(19) United States
(12) Patent Application Publication
(10) Pub. No.: US 2025/0066558 A1
(43) Pub. Date: Feb. 27, 2025

(54) AEROGELS ASSEMBLED FROM MICROFIBERS, METHODS FOR THEIR PREPARATION AND USES THEREOF

(71) Applicant: THE UNIVERSITY OF BRITISH COLUMBIA, Vancouver (CA)

(72) Inventors: Jiaying ZHU, Vancouver (CA); Feng JIANG, Vancouver (CA); Yifan ZHANG, Vancouver (CA); Marc MASSICOTTE, Vancouver (CA)

(21) Appl. No.: 18/947,297

(22) Filed: Nov. 14, 2024

Related U.S. Application Data
(63) Continuation of application No. PCT/CA2024/050168, filed on Feb. 8, 2024.
(60) Provisional application No. 63/444,330, filed on Feb. 9, 2023.

(51) Int. Cl. C08J 3/075; D01F 2/24; D01F 11/02; D01F 11/14; D21C 9/00

(52) U.S. Cl. CPC C08J 3/075; D01F 2/24; D01F 11/02; D01F 11/14; D21C 9/007; C08J 2397/02; D10B 2201/01; D10B 2401/021; D10B 2401/061

(57) ABSTRACT

The present disclosure relates to aerogels (e.g., superelastic, ultralight and/or thermal super-insulating aerogels), methods for preparation of such aerogels and uses of such aerogels. For example, the methods for preparation can comprise: freezing a suspension comprising high aspect ratio microfibers; and freeze-drying the frozen suspension to obtain the aerogel.

### CROSS-REFERENCE TO RELATED APPLICATIONS

The present disclosure claims the benefit of priority from co-pending U.S. provisional application No. 63/444,330 filed on Feb. 9, 2023, the contents of which are incorporated herein by reference in their entirety.

### FIELD

The present disclosure relates to aerogels (e.g., superelastic, ultralight and/or thermal super-insulating aerogels), methods for preparation of such aerogels and uses thereof.

### BACKGROUND

With a three-dimensional interconnected porous structure, aerogel represents a type of emerging lightweight monolithic solid, with low density and high porosity (Ahankari et al., 2021; Wei et al., 2022). Due to the low solid content and high structural tortuosity, the heat conduction and convection through these porous materials can be substantially reduced (Apostolopoulou-Kalkavoura et al., 2021; Song et al., 2020). This suggests aerogels' potential application as thermal super-insulating materials, i.e., those with thermal conductivity lower than 0.025 W m⁻¹ K⁻¹ (Koebel et al., 2012). For instance, aerogels have been commercialized as thermal insulation products including building insulation and thermal insulation fabric (Cuce et al., 2014; Zhang et al., 2023; Yin et al., 2022). Conventionally, aerogels have been made from inorganic materials and petrochemical polymers, such as silica, carbon, phenolic resin and polyimide (Pierre et al., 2002; Yu et al., 2018; Qin et al., 2015; Liu et al., 2018a; Sun et al., 2013). Recently, studies have identified the feasibility of fabricating sustainable aerogels using bio-based materials, particularly cellulose (Jiang and Hsieh, 2014; Ferreira et al., 2021; Zhu et al., 2022a; Zhu et al., 2022b), the most abundant biopolymer on earth. However, because of low elastic strain and irreversible structural collapse under compression (Kim et al., 2015), aerogels made from cellulose are generally not suitable for a flexible thermal insulation application such as fillers for winter jackets.

The mechanical properties of aerogels are governed by the intrinsic properties of the building blocks, the interaction between building blocks during assembly, and the geometric morphology of the assembled structure (Liu et al., 2018b; Mi et al., 2018; Qin et al., 2023). A major issue with regard to cellulosic aerogels' poor elasticity is correlated to the geometric feature of the assembled cellular structure (Qin et al., 2021). Cellulosic aerogels prepared using ice-templating/freeze drying typically have a honeycomb porous morphology, i.e., cellulose assembles and makes up the walls between neighboring microscale cells. When subject to compression and shearing, plastic deformation easily takes place at the compact cellulosic walls, which accounts for the permanent structural failure and poor elasticity of the aerogel. Rationally designing the microstructure of aerogels helps improve their elasticity. For instance, researchers have developed superelastic aerogels from polymeric and inorganic nanofibers with satisfactory shape recovery from high-strain and cyclic compressions (Huang et al., 2022; Si et al., 2018; Zhang et al., 2022; Xu et al., 2021). Their superelasticity is believed to arise from the interconnected fibrous walls, which are different from the compact walls. Particularly, the interconnected fibrous walls, composed of continuous microscale fibers, mitigate the irreversible structural collapse and improve the aerogel's resilience to high-strain compression. However, fabricating cellulosic aerogels with similar microscale morphology to these polymeric or inorganic nanofibers aerogel is complex and often relies on bottom-up strategy that involves chemical dissolution and/or assistance of other synthetic polymers to fabricate continuous fibers by electrospinning as the first step (Pirzada et al., 2020; Xu et al., 2018; Qin et al., 2022; Jiang et al., 2018). A recent study proposed a dual ice-templating method to fabricate continuous sub-micron fibers from nanocellulose for superelastic aerogel application (Qin et al., 2021). However, this process is quite energy intensive and time consuming. From a green chemistry point of view, developing a scalable strategy to prepare superelastic cellulosic aerogels from renewable biomass with minimum chemical use is of great interest to sustainable development.

### SUMMARY

An exemplary simple strategy for scalable production of superelastic hemp aerogel is disclosed herein which comprised chemical delignification, mechanical blending, and ice-templating assembly. A resulting aerogel showed isotropic and temperature-invariant superelasticity. The high porosity (99.87%) endowed the aerogel with a low thermal conductivity of 0.0215 W m⁻¹ K⁻¹, showing good thermal insulation performance. This simple approach to fabricate superelastic aerogel can be adapted and/or extended, for example, to other natural fibers with similar properties to obtain aerogels with useful properties. For example, aerogels with desirable elasticity were prepared from other exemplary high aspect ratio microfibers.

Accordingly, the present disclosure includes a method of preparing an aerogel, the method comprising:
freezing a suspension comprising high aspect ratio microfibers; and
freeze-drying the frozen suspension to obtain the aerogel.

In an embodiment, the microfibers have an average diameter of from about 1 μm to about 50 μm and an average aspect ratio of from about 40 to about 130. In another embodiment, the microfibers have an average diameter of from about 4 μm to about 10 μm and an average aspect ratio of from about 100 to about 120.

In an embodiment, the microfibers comprise cellulose.

In an embodiment, the microfibers are derived from bast fiber. In another embodiment, the bast fiber is from hemp, jute, flax, ramie, kenaf, bamboo or combinations thereof. In a further embodiment, the bast fiber is from hemp.

In an embodiment, the bast fiber has been delignified.

In an embodiment, the microfibers are prepared by a method comprising mechanical defibrillation.

In an embodiment, the suspension comprises a solvent selected from water, tert-butanol, dimethyl sulfoxide and mixtures thereof.

In an embodiment, the suspension is an aqueous suspension comprising the microfibers in an amount of from about 0.01 wt % to about 2 wt %, based on the total weight of the aqueous suspension. In another embodiment, the aqueous suspension comprises the microfibers in an amount of about 0.2 wt %, based on the total weight of the aqueous suspension.

In an embodiment, the suspension further comprises a crosslinking agent. In another embodiment, the crosslinking agent comprises polyamideamine-epichlorohydrin. In a further embodiment, the crosslinking agent is present in the suspension in an amount of from about 0.1 wt % to about 2 wt %, based on the amount of the microfibers.

In an embodiment, the freezing is at a temperature in the range of from about −4° C. to about −50° C. In another embodiment, the freezing is at a temperature of about −20° C.

In an embodiment, the method further comprises modifying a surface of the aerogel with a hydrophobic surface modifying agent. In another embodiment, the modifying the surface comprises chemical vapor deposition of methyltrimethoxysilane.

The present disclosure also includes an aerogel prepared by a method of preparing an aerogel as described herein.

The present disclosure also includes an aerogel comprising a honeycomb structure, the cell walls of the honeycomb structure comprising high aspect ratio microfibers.

In an embodiment, the microfibers have an average diameter of from about 1 μm to about 50 μm and an average aspect ratio of from about 40 to about 130. In another embodiment, the microfibers have an average diameter of from about 4 μm to about 10 μm and an average aspect ratio of from about 100 to about 120.

In an embodiment, the microfibers comprise cellulose.

In an embodiment, the microfibers are derived from bast fiber. In another embodiment, the bast fiber is from hemp, jute, flax, ramie, kenaf, bamboo or combinations thereof. In a further embodiment, the bast fiber is from hemp.

In an embodiment, the bast fiber has been delignified.

In an embodiment, the microfibers have been prepared by a method comprising mechanical defibrillation.

In an embodiment, the aerogel comprises microfibers that have been crosslinked with a crosslinking agent. In another embodiment, the crosslinking agent comprises polyamideamine-epichlorohydrin.

In an embodiment, a surface of the aerogel is modified with a hydrophobic surface modifying agent. In another embodiment, the hydrophobic surface modifying agent comprises methyltrimethoxysilane.

In an embodiment, density of the aerogel is from about 1.5 mg/cm³ to about 21 mg/cm³. In another embodiment, the density of the aerogel is about 2.1 mg/cm³.

In an embodiment, porosity of the aerogel is from about 98.5% to about 99.9%.

In an embodiment, the aerogel has isotropic superelasticity.

In an embodiment, the aerogel is a thermal super-insulating material.

The present disclosure also includes apparel or outdoor gear comprising an aerogel as described herein as a thermal insulator.

The present disclosure also includes a use of an aerogel of the present disclosure for oil-water separation, as an absorbent, as a thermal insulator, as an acoustic insulator, as a drug carrier, as a tissue scaffold, as an infrared shield, in packaging and/or in a sensor.

In an embodiment, the aerogel is for use as a thermal insulator in apparel.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should rather be given the broadest interpretation consistent with the description as a whole.

### BRIEF DESCRIPTION OF THE DRAWINGS

FIGS. 1-4 show the design, process and structures of ultralow density hemp microfibers aerogel. FIG. 1 is a schematic showing the synthetic steps in an exemplary process comprising hemp microfibers. FIGS. 2-6 are exemplary photos showing different properties of the hemp aerogels, representing ultralight (FIG. 2), superelastic (FIG. 3), flexible (FIG. 4), shapeable (FIG. 5), and scalable (FIG. 6) properties. Scale bar in FIG. 6 shows 2 cm.

FIGS. 7-12 show characterization of hemp bast fibers before and after different treatments. FIG. 7 shows exemplary polarized optical microscopy images of original hemp bast fibers (upper image), delignified fibers (middle image), and microfibers (lower image). Scale bars in FIG. 7 show 100 μm. FIG. 8 shows fiber diameter distribution measured using a nano measurer (over 100 statistical individual fibers) for delignified fiber (upper plot) and microfiber (lower plot). FIG. 9 shows fiber length distribution for microfibers measured using Image J (over 100 statistical individual fibers). FIG. 10 is an exemplary X-ray diffraction (XRD) diffractogram for the original bast fibers (black line), delignified fibers (**) and microfiber (*). FIG. 11 shows Fourier-transform infrared (FTIR) spectra of original bast (upper) and delignified hemp fibers (lower). FIG. 12 shows photos of hemp microfiber suspension (0.2 wt %; left image) and standing for one month (right image).

FIG. 13 shows FTIR spectra of an exemplary hemp aerogel (upper) and an exemplary hemp aerogel crosslinked with polyamide-epichlorohydrin (PAE).

FIG. 14 shows photos of exemplary aerogel under water with PAE (lower left image) and without PAE (upper left image) and one week later (right respective images).

FIG. 15 shows strain and stress curves for exemplary aerogel with PAE (**) and without PAE (*). Both densities are 2.1 mg cm⁻³.

FIGS. 16-23 show compressive properties of the hemp aerogels. FIG. 16 shows photos of the hemp aerogel before (left images) and after (right images) 80% strain (center images) for aerogels with the density of 21 mg cm⁻³ (upper images) and 2.1 mg cm⁻³ (lower images). The photos of the ultralight hemp aerogel show superelasticity along the vertical direction. FIG. 17 shows scanning electron microscopy (SEM) images of aerogels before compression and FIG. 18 shows SEM images of aerogels after compression for 2.1 mg cm⁻³ aerogel (left images), and for 21 mg cm⁻³ aerogel (right images). Scale bars in FIGS. 17 and 18 show 200 μm. FIG. 19 shows the corresponding magnified images for cell walls before compression. Scale bars in FIG. 19 show 2 μm. FIG. 20 shows photos showing the elastic performance when an exemplary 0.1 wt % aerogel undergoes 80% strain. FIG. 21 shows photos of ultralight hemp aerogel showing superelasticity along the transverse direction. FIG. 22 shows photos of ultralight hemp aerogel showing superelasticity in an extreme cold environment. FIG. 23 shows photos showing the elastic performance when an exemplary aerogel without PAE undergoes 80% strain.

FIGS. 24-27 show multicycle compressive properties of the low-density hemp aerogels (2.1 mg cm⁻³). FIG. 24 is a plot showing compressive stress versus strain curves during loading-unloading cycles with increasing strain amplitude (20%, 40%, 60% and 80%). FIG. 25 is a plot showing a 100-cycle fatigue test with 40% compressive strain. FIG. 26 is a plot showing the ultimate stress at 40% strain (left columns for each number of cycles, from left to right: 1, 20, 40, 60, 80 and 100) and energy loss coefficient (right columns for each number of cycles, from left to right: 1, 20, 40, 60, 80 and 100) curves of the aerogel. FIG. 27 is a plot showing ultimate stress at 40% strain (left columns for each number of cycles, from left to right: 1, 20, 40, 60, 80 and 100) and energy loss coefficient (right columns for each number of cycles, from left to right: 1, 20, 40, 60, 80 and 100) curves of the aerogel along transverse direction.

FIGS. 28-30 show the mechanical properties of aerogels with different hemp concentrations. FIG. 28 shows strain and stress curves (from top to bottom, concentrations of 2, 1.5, 1, 0.8, 0.5 and 0.2 wt %) and FIG. 29 shows the corresponding Young's modulus (left columns for each concentration, from left to right: 0.2, 0.5, 0.8, 1.0, 1.5 and 2.0 wt %), and yield stress (right columns for each concentration, from left to right: 0.2, 0.5, 0.8, 1.0, 1.5 and 2.0 wt %). FIG. 30 shows specific modulus (left columns for each concentration, from left to right: 0.2, 0.5, 0.8, 1.0, 1.5 and 2.0 wt %) and densities (right columns for each concentration, from left to right: 0.2, 0.5, 0.8, 1.0, 1.5 and 2.0 wt %).

FIGS. 31-36 show characterization, including hydrophobic and oil-absorption properties of methyltrimethoxysilane (MTMS)-hemp aerogel, FIG. 37 shows porosity of aerogels with different hemp concentrations of, from left to right: 2.0, 1.5, 1.0, 0.8, 0.5 and 0.2 wt %, and FIGS. 38 and 39 show further characterization, including oil-absorption properties of MTMS-hemp aerogel. For example, FIG. 31 shows FTIR spectra of the MTMS-hemp aerogel (lower spectrum) in comparison to the uncoated hemp aerogel (upper spectrum). FIG. 32 shows an energy dispersive X-ray spectroscopy (EDX) elemental (Si) mapping image of MTMS-hemp aerogel (left image; scale bar shows 200 μm) and an EDX spectrum (right image). FIG. 33 shows water contact angle over time at, from left to right: 1, 5, 15 and 30 minutes. FIG. 34 shows dynamic water contact angle (advancing, left and receding angle, right) detected on MTMS-hemp aerogel surface. FIG. 35 is a digital photo of various colored aqueous solutions deposited on MTMS-hemp aerogel surface. FIG. 36 shows photographs of water droplet standing on side (left image) and inner surface (right image) of MTMS-hemp aerogel. FIG. 38 shows mass-based (g liquid per g of aerogel) absorption capacity towards different organic solvents and oils. FIG. 39 shows absorption capacity of the MTMS-hemp aerogel after multiple cycles.

FIGS. 40-45 show thermal properties of superelastic aerogel. FIG. 40 shows thermal conductivity of aerogel at different hemp concentrations, from left to right: 0.2, 0.5, 0.8, 1.0, 1.5 and 2.0 wt %. FIG. 41 shows temperature-versus-time curves of ultralight aerogel (thickness: 25 mm) on hot plate. FIG. 42 shows temperature-versus-time curves of ultralight aerogel (thickness: 25 mm) on ice. FIG. 43 shows infrared (IR) images of superelastic aerogel on the hot plate during the course of 120 minutes, from left to right in upper row: 0.5, 1.0, 2.0 and 5.0 minutes and from left to right in lower row: 15, 30, 60 and 120 minutes (scale bar shows 1 cm). FIG. 44 shows a photograph of fabric filled with aerogel wrapped on a human forearm (top), and the corresponding IR image (bottom). FIG. 45 shows temperature-time curves of the temperature of the skin covered by the fabric and room temperature.

FIG. 46 shows exemplary microscope images of delignified hemp fiber after mechanical blending for a duration of 16 minutes (aspect ratio about 110, diameter about 6.7 μm). Scale bar in left image shows 200 μm. Scale bar in right image shows 100 μm.

FIG. 47 shows exemplary microscope images of microfibrillated cellulose after treatment of Northern bleached softwood kraft pulp (NBSK) using a Supermass Colloider (MFC1; aspect ratio about 56, diameter about 36 μm). Scale bar in each image shows 100 μm.

FIG. 48 shows an exemplary microscope image of NBSK pulp (aspect ratio about 60, diameter about 40 μm). Scale bar shows 200 μm.

FIG. 49 shows an exemplary microscope image of TEMPO-oxidized cellulose nanofibrils (CNF) after mechanical blending for a duration of 20 minutes (aspect ratio about 264, diameter about 20 nm). Scale bar shows 500 nm.

FIG. 50 shows exemplary photographs showing elastic performance of an exemplary aerogel derived from hemp fibers.

FIG. 51 shows exemplary photographs showing elastic performance of an exemplary aerogel derived from MFC1.

FIG. 52 shows exemplary photographs showing elastic performance of an exemplary aerogel derived from NBSK.

FIG. 53 shows exemplary photographs showing elastic performance of an exemplary aerogel derived from CNF.

FIG. 54 shows exemplary microscope images of MFC1 after mechanical blending for a duration of 10 minutes (MFC2, diameter about 10 μm). Scale bar in each image shows 100 μm.

FIG. 55 shows exemplary photographs showing MFC2 failed to form an aerogel under conditions similar to the preparation of the aerogel derived from MFC1.

### DETAILED DESCRIPTION

### I. Definitions

Unless otherwise indicated, the definitions and embodiments described in this and other sections are intended to be applicable to all embodiments and aspects of the disclosure herein described for which they would be understood to be suitable by a person skilled in the art.

As used herein, the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process/method steps. As used herein, the word “consisting” and its derivatives, are intended to be close ended terms that specify the presence of stated features, elements, components, groups, integers, and/or steps, and also exclude the presence of other unstated features, elements, components, groups, integers and/or steps. The term “consisting essentially of” and any form thereof, as used herein, is intended to specify the presence of the stated features, elements, components, groups, integers, and/or steps as well as those that do not materially affect the basic and novel characteristic(s) of these features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this disclosure, the singular forms “a”, “an” and “the” include plural references unless the content clearly dictates otherwise.

The term “and/or” as used herein means that the listed items are present, or used, individually or in combination. In effect, this term means that “at least one of” or “one or more” of the listed items is used or present.

The term “alkyl” as used herein, whether it is used alone or as part of another group, means straight or branched chain, saturated alkyl groups. The number of carbon atoms that are possible in the referenced alkyl group are indicated by the numerical prefix “Cₙ₁₋ₙ₂”. For example, the term C₁₋₆alkyl means an alkyl group having 1, 2, 3, 4, 5 or 6 carbon atoms.

The term “suitable” as used herein means that the selection of the particular compound, material and/or conditions would depend on the specific manipulations to be performed, and/or the identity of the compound(s) and/or material(s) to be transformed, but the selection would be well within the skill of a person skilled in the art. All method steps described herein are to be conducted under conditions sufficient to provide the product shown.

The term “superelastic” and the like as used herein refers to an aerogel capable of undergoing large deformation (e.g., a compression strain of at least 50% to 80% strain or greater) and at least substantially, optionally completely recover the deformation during the unloading phase substantially immediately, for example in a time of less than 10, 5, or 3 seconds.

The term “thermal super-insulating material” and the like as used herein refers to an aerogel having a thermal conductivity lower than 0.025 W m⁻¹ K⁻¹.

The term “high aspect ratio microfibers” as used herein refers to a suitable microfiber of a material having an elongated form, for example, wherein the average diameter is less than about 50 μm, and the aspect ratio is above 50. The term “high aspect ratio microfibers” as used herein includes materials that are completely in the form of high aspect ratio microfibers but may also include materials with suitable amounts of material outside of that form; e.g., materials that comprise or consist essentially of high aspect ratio microfibers but also include material outside of that form such as fibers having average diameters and/or aspect ratios outside of these ranges. For example, in some embodiments, the high aspect ratio microfibers may also comprise suitable amounts of nanofibers, such as but not limited to nanofibers produced during methods comprising defibrillation of a source of the high aspect ratio microfibers. The term “nanofibers” as used herein refers to a fiber of a material, typically having an elongated form (but may also, in some embodiments, include suitable other forms such as suitable particles), wherein the average diameter is less than 1000 nm, e.g. from 100 nm to 1000 nm.

### II. Methods

Herein, an exemplary superelastic aerogel was developed from hemp bast fibers using a simple top-down defibrillation treatment, leading to microfibers with high aspect ratio, which were further assembled by ice-templating and freeze drying. The developed aerogels showed excellent isotropic elasticity at ultralow density (2.1 mg cm⁻³) under 80% compressive strain. The unique cellular wall, consisting of well-bonded and continuous microfibers, endows hemp aerogels with low thermal conductivity (0.0215±0.0002 W m⁻¹ K⁻¹) and good superelasticity at an extremely low environmental temperature of −173° C. Furthermore, it was demonstrated that the aerogel's water stability and hydrophobicity can be easily improved by proper chemical modification. Such hemp microfiber-based aerogel represents a useful bio-based thermal insulation material that can potentially replace traditional petrochemical-based ones. This simple approach to fabricate superelastic aerogel could be extended to other natural fibers with similar properties. For example, aerogels with desirable elasticity were prepared from other exemplary high aspect ratio microfibers.

Accordingly, the present disclosure includes a method of preparing an aerogel, the method comprising:
freezing a suspension comprising high aspect ratio microfibers; and
freeze-drying the frozen suspension to obtain the aerogel.

In an embodiment, the microfibers have an average diameter of from about 1 μm to about 50 μm. In another embodiment, the microfibers have an average diameter of from about 4 μm to about 10 μm. In a further embodiment, the microfibers have an average diameter of about 7 μm. In an embodiment, the microfibers have an average aspect ratio of from about 40 to about 130. In another embodiment, the microfibers have an average aspect ratio of greater than 60. In another embodiment, the microfibers have an average aspect ratio of from about 100 to about 120. In a further embodiment, the microfibers have an average aspect ratio of about 110. In an embodiment, the microfibers have an average diameter of from about 1 μm to about 50 μm and an average aspect ratio of from about 40 to about 130. In another embodiment, the microfibers have an average diameter of from about 4 μm to about 10 μm and an average aspect ratio of from about 100 to about 120. In a further embodiment, the microfibers have an average diameter of about 7 μm and an average aspect ratio of about 110.

The microfibers can comprise any suitable material or combination thereof. In an embodiment, the microfibers comprise a bio-based material such as cellulose, chitosan, protein or combinations thereof from a suitable source. In an embodiment, the microfibers are derived from bast fiber, another suitable plant source such as from plant seed fibers (e.g., cotton, coir, kapok or combinations thereof), a suitable source of protein-based fibers (e.g., silk, wool or combinations thereof), regenerated cellulose, chitosan or combinations thereof. In another embodiment, the microfibers comprise cellulose. In an embodiment, the microfibers are derived from bast fiber. In an embodiment, the bast fiber is from hemp, jute, flax, ramie, kenaf, bamboo or combinations thereof. In another embodiment, the bast fiber is from hemp. It will be appreciated by a person skilled in the art that microfibers comprising cellulose can optionally comprise additional non-cellulosic components. For example, plant-derived cellulose raw materials typically comprise cellulose in admixture with other substances such as hemicellulose, lignin and/or pectin. In some embodiments, the cellulose raw material is treated to remove at least a portion of non-cellulosic components. Methods for treating cellulose raw material to remove non-cellulosic components are well known in the art and may depend, for example, on the particular cellulose raw material. A suitable method for treating cellulose raw material to remove non-cellulosic components can be readily selected by a person skilled in the art. In an embodiment, the method comprises delignification. In an embodiment, the microfibers are derived from bast fiber and the bast fiber has been delignified.

Suitable microfibers can be prepared using known methods and/or means, the selection of which can readily be made by a person skilled in the art. In an embodiment, the microfibers are prepared by a method comprising mechanical defibrillation, chemical defibrillation or combinations thereof. In an embodiment, the microfibers are prepared by a method comprising mechanical defibrillation. The mechanical defibrillation can comprise any suitable method and/or means, the selection of which can also be readily made by a person skilled in the art. For example, in an embodiment, the mechanical defibrillation comprises blending (e.g., high-speed blending), homogenizing (e.g., high-pressure homogenizing), microfluidizing, disc grinding, sonication or combinations thereof. In another embodiment, the mechanical defibrillation comprises high-speed blending.

The suspension can comprise any suitable solvent or combination thereof. In an embodiment, the solvent comprises, consists essentially of or consists of water, tert-butanol, dimethyl sulfoxide or combinations thereof. In another embodiment, the suspension is an aqueous suspension comprising the microfibers. The concentration of the microfibers in the aqueous suspension is any suitable concentration. For example, in some embodiments, the aqueous suspension comprises the microfibers in an amount suitable to achieve a homogeneous suspension. For example, in an embodiment, the aqueous suspension comprises the microfibers in an amount of less than about 2 wt %, based on the total weight of the aqueous suspension. In another embodiment, the aqueous suspension comprises the microfibers in an amount of from about 0.01 wt % to about 2 wt %, based on the total weight of the aqueous suspension. In a further embodiment, the aqueous suspension comprises the microfibers in an amount of from about 0.2 wt % to about 2 wt %, based on the total weight of the aqueous suspension. It will be appreciated by a person skilled in the art having regard to the present disclosure that the properties of the aerogels produced by the methods of the present disclosure may vary, for example, based on the concentration of the microfibers in the aqueous suspension. For example, an aerogel prepared using a concentration of 0.2 wt % cellulose microfibers demonstrated superelastic behaviour. In an embodiment, the aqueous suspension comprises the microfibers in an amount of about 0.1 wt % to about 0.3 wt % or about 0.2 wt %. In a further embodiment, the aqueous suspension comprises the microfibers in an amount of 0.1 wt %, 0.2 wt %, 0.5 wt %, 0.8 wt %, 1.0 wt %, 1.5 wt % or 2.0 wt %.

The term “aqueous” as used herein in reference to a suspension includes suspensions wherein the solvent consists of water but also includes aqueous suspensions that include minor amounts of another solvent or mixtures thereof, for example, less than about 5 wt %, 4 wt %, 3 wt %, 2 wt %, 1 wt %, 0.5 wt %, 0.1 wt %, 0.05 wt % or 0.01 wt % of the other solvent or mixture thereof so long as the presence of the other solvent or mixture thereof, as the case may be, still allows for suitable conditions for obtaining the aerogel.

In some embodiments, the suspension further comprises a crosslinking agent. The term “crosslinking agent” as used herein refers to a compound capable of reacting with reactive functional groups on the microfibers (sometimes referred to herein as hetero-crosslinking) so as to form a linkage between a first microfiber and a second microfiber and/or a first site on a microfiber with a second site on the microfiber. The crosslinking agent can be any suitable crosslinking agent, the selection of which can be made by a person skilled in the art. For example, it will be appreciated by the skilled person that the identity of the crosslinking agent will depend, for example on the nature of the reactive group(s) present in the microfiber. In some embodiments, the crosslinking agent is a compound capable of additionally reacting with itself (sometimes referred to herein as homo-crosslinking). In an embodiment, the microfibers comprise cellulose and the crosslinking agent is a wet strength resin capable of both hetero-crosslinking and homo-crosslinking. In an embodiment, the crosslinking agent comprises polyamideamine-epichlorohydrin. In another embodiment, the crosslinking agent is present in the suspension in an amount of from about 0.1 wt % to about 2 wt %, based on the amount of the microfibers. In a further embodiment, the crosslinking agent is present in the suspension in an amount of about 1 wt %, based on the amount of the microfibers. It will be appreciated by a person skilled in the art that certain crosslinking agents may require heating so as to at least substantially complete the crosslinking process. Accordingly, in some embodiments, subsequent to freeze-drying, the method further comprises heating the aerogel for a time and at a temperature suitable to at least substantially optionally fully complete the crosslinking process. In an embodiment, the heating is for a time of about 1 hour to about 6 hours or about 3 hours at a temperature of about 80° C. to about 140° C. or about 120° C.

The conditions for obtaining the aerogel including, for example, the temperature during the freezing can be any suitable conditions allowing for the microfibers to be interconnected and an aerogel having pores (e.g., comprising a honeycomb structure) to be obtained. For example, a person skilled in the art having regard to the present disclosure would readily appreciate that the conditions for obtaining the aerogel including, for example, the temperature during the freezing should be selected such that ice crystals of a suitable size for templating such pores are formed. In an embodiment, the freezing is at a temperature in the range of from about −4° C. to about −50° C. In another embodiment, the freezing is at a temperature in the range of from about −10° C. to about −30° C. or about −20° C. In an embodiment, the suspension is frozen for a time of about 30 minutes to about 24 hours or about 3 hours. The conditions for freeze-drying the frozen suspension comprising the microfibers are any suitable conditions, the selection of which can be readily made by a person skilled in the art. In an embodiment, the frozen suspension is freeze-dried to obtain the aerogel at a temperature of about −20° C. to about −75° C. or about −50° C. at a pressure of about 0.05 mBar to about 0.2 mBar or about 0.12 mBar for a time of about 6 hours to about 4 days or about 48 hours, optionally a time until substantially all of the solvent is removed.

In an embodiment, the method further comprises modifying a surface of the aerogel with a hydrophobic surface modifying agent. The term “hydrophobic surface modifying agent” as used herein refers to an agent that can be used to modify a surface of the aerogel such that the surface is less hydrophilic (i.e., has greater hydrophobicity) than the surface of a corresponding aerogel that has not been modified by the agent. The hydrophobic surface modifying agent can be any suitable hydrophobic surface modifying agent and can be readily selected by a person skilled in the art. In an embodiment, the hydrophobic surface modifying agent is a suitable silane, such as a silane of the Formula (I):

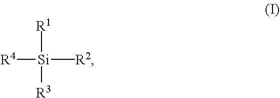

wherein R¹ is C₁₋₆alkyl and R², R³ and R⁴ are each independently chosen from C₁₋₆alkyl, hydroxy and a group that is hydrolysable under conditions to modify the surface, provided that at least one of R², R³ and R⁴ is a hydroxy or a group that is hydrolysable under conditions to modify the surface. A person skilled in the art would readily understand what groups are hydrolysable under particular conditions used to modify the surface and would be able to select a suitable silane and conditions accordingly. In an embodiment, R¹ is C₁₋₆ alkyl and R², R³ and R⁴ are each independently C₁₋₆alkoxy. In another embodiment, R¹ is methyl. In a further embodiment, R², R³ and R⁴ are each methoxy. In an embodiment, the hydrophobic surface modifying agent is methyltrimethoxysilane. In an embodiment, the modifying the surface comprises chemical vapor deposition of the hydrophobic surface modifying agent (e.g., the suitable silane such as methyltrimethoxysilane). However, any suitable method for modifying the surface with a hydrophobic surface modifying agent may be used such as solution-based methods. It will be appreciated that in embodiments wherein the method comprises heating so as to at least substantially complete a crosslinking process associated with a crosslinking agent, the method would typically comprise modifying the surface of the aerogel subsequent to such heating.

### III. Aerogels and Uses Thereof

The present disclosure also includes an aerogel prepared by a method of preparing an aerogel as described herein. It will be appreciated by a person skilled in the art that embodiments relating to such aerogels may be varied as discussed above in relation to the methods.

The present disclosure also includes an aerogel comprising a honeycomb structure, the cell walls of the honeycomb structure comprising high aspect ratio microfibers.

In an embodiment, the microfibers have an average diameter of from about 1 μm to about 50 μm. In another embodiment, the microfibers have an average diameter of from about 4 μm to about 10 μm. In a further embodiment, the microfibers have an average diameter of about 7 μm. In an embodiment, the microfibers have an average aspect ratio of from about 40 to about 130. In another embodiment, the microfibers have an average aspect ratio of greater than 60. In another embodiment, the microfibers have an average aspect ratio of from about 100 to about 120. In a further embodiment, the microfibers have an average aspect ratio of about 110. In an embodiment, the microfibers have an average diameter of from about 1 μm to about 50 μm and an average aspect ratio of from about 40 to about 130. In another embodiment, the microfibers have an average diameter of from about 4 μm to about 10 μm and an average aspect ratio of from about 100 to about 120. In a further embodiment, the microfibers have an average diameter of about 7 μm and an average aspect ratio of about 110.

In an embodiment, the microfibers comprise a bio-based material such as cellulose, chitosan, protein or combinations thereof from a suitable source. In an embodiment, the microfibers are derived from bast fiber, another suitable plant source such as from plant seed fibers (e.g., cotton, coir, kapok or combinations thereof), a suitable source of protein-based fibers (e.g., silk, wool or combinations thereof), regenerated cellulose, chitosan or combinations thereof. In another embodiment, the microfibers comprise cellulose. In an embodiment, the microfibers are derived from bast fiber. In an embodiment, the bast fiber is from hemp, jute, flax, ramie, kenaf, bamboo or combinations thereof. In another embodiment, the bast fiber is from hemp. It will be appreciated by a person skilled in the art that microfibers comprising cellulose can optionally comprise additional non-cellulosic components. For example, plant-derived cellulose raw materials typically comprise cellulose in admixture with other substances such as hemicellulose, lignin and/or pectin. In some embodiments, the cellulose raw material has been treated to remove at least a portion of non-cellulosic components. In an embodiment, the microfibers are derived from a cellulose raw material that has been subjected to delignification. In an embodiment, the microfibers are derived from bast fiber and the bast fiber has been delignified.

In an embodiment, the microfibers have been prepared by a method comprising mechanical defibrillation, chemical defibrillation or combinations thereof. In an embodiment, the microfibers have been prepared by a method comprising mechanical defibrillation. The mechanical defibrillation can comprise any suitable method and/or means, the selection of which can be readily made by a person skilled in the art. For example, in an embodiment, the mechanical defibrillation comprises blending (e.g., high-speed blending), homogenizing (e.g., high-pressure homogenizing), microfluidizing, disc grinding, sonication or combinations thereof. In another embodiment, the mechanical defibrillation comprises high-speed blending.

In some embodiments, the aerogel comprises microfibers that have been crosslinked with a crosslinking agent. The crosslinking agent can be any suitable crosslinking agent, the selection of which can be made by a person skilled in the art. For example, it will be appreciated by the skilled person that the identity of the crosslinking agent will depend, for example on the nature of the reactive group(s) present in the microfiber. In some embodiments, the crosslinking agent is a compound additionally capable of homo-crosslinking. In an embodiment, the microfibers comprise cellulose and the crosslinking agent is a wet strength resin capable of both hetero-crosslinking and homo-crosslinking. In an embodiment, the crosslinking agent comprises polyamideamine-epichlorohydrin. In another embodiment, the crosslinking agent is present in an amount of from about 0.1 wt % to about 2 wt %, based on the amount of the microfibers. In a further embodiment, the crosslinking agent is present in an amount of about 1 wt %, based on the amount of the microfibers.

In an embodiment, a surface of the aerogel is modified with a hydrophobic surface modifying agent. The hydrophobic surface modifying agent can be any suitable hydrophobic surface modifying agent and can be readily selected by a person skilled in the art. In an embodiment, the hydrophobic surface modifying agent is a suitable silane, such as a silane of the Formula (I):

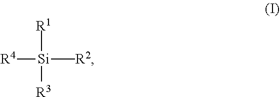

wherein R¹ is C₁₋₆alkyl and R², R³ and R⁴ are each independently chosen from C₁₋₆alkyl, hydroxy and a group that is hydrolysable under conditions to modify the surface, provided that at least one of R², R³ and R⁴ is a hydroxy or a group that is hydrolysable under conditions to modify the surface. A person skilled in the art would readily understand what groups are hydrolysable under particular conditions used to modify the surface and would be able to select a suitable silane and conditions accordingly. In an embodiment, R¹ is C₁₋₆ alkyl and R², R³ and R⁴ are each independently C₁₋₆alkoxy. In another embodiment, R¹ is methyl. In a further embodiment, R², R³ and R⁴ are each methoxy. In an embodiment, the hydrophobic surface modifying agent is methyltrimethoxysilane. It will be appreciated by a person skilled in the art that in embodiments wherein more than one of R², R³ and R⁴ are hydroxy and/or a group that is hydrolysable under conditions to modify the surface, the exact structure of the siloxane of the modified surface may vary. For example, an oxygen atom may be bonded to two silicon atoms, e.g., in a siloxane network, or to a silicon atom at one end and to a suitable atom in the remainder of the aerogel at the other, for example, a carbon atom, wherein the —Si—O—C— bond is formed from reaction with a surface hydroxyl of cellulose or another component in the aerogel. Additionally, a person skilled in the art would understand that in such embodiments, optionally not all of the hydroxy groups and/or groups that are hydrolysable under conditions to modify the surface may participate in a condensation reaction such that the surface-modified aerogel may comprise variable amounts of Si—OH groups. In an embodiment, the weight concentration of Si in the surface modified aerogel is from about 1 wt % to about 20 wt %, about 1 wt % to about 10 wt % or about 5 wt %.

In an embodiment, density of the aerogel is from about 1.5 mg/cm³ to about 21 mg/cm³. In another embodiment, density of the aerogel is from about 2 mg/cm³ to about 16 mg/cm³, about 2 mg/cm³ to about 12 mg/cm³, about 2 mg/cm³ to about 10 mg/cm³, or about 2 mg/cm³ to about 5 mg/cm³. In a further embodiment, density of the aerogel is about 2.1 mg/cm³.

In an embodiment, porosity of the aerogel is greater than about 98%. In another embodiment, porosity of the aerogel is from about 98.5% to about 99.9%, about 98.5% or greater, about 99.0% or greater, about 99.5% or greater or about 99.9%.

In an embodiment, the aerogel has isotropic superelasticity.

In an embodiment, the aerogel is a thermal super-insulating material.

The present disclosure also includes apparel (e.g., a winter jacket) or outdoor gear (e.g., a sleeping bag) comprising an aerogel as described herein (including an aerogel prepared by a method of the present disclosure) as a thermal insulator.

The present disclosure also includes a use of an aerogel of the present disclosure (including an aerogel prepared by a method of the present disclosure) for oil-water separation, as an absorbent, as a thermal insulator, as an acoustic insulator, as a drug carrier, as a tissue scaffold, as an infrared shield, in packaging and/or in a sensor. In an embodiment, the aerogel is for use for oil-water separation. In another embodiment, the aerogel is for use as an absorbent. In a further embodiment, the aerogel is for use as a thermal insulator. In an embodiment, the aerogel is for use as a thermal insulator in apparel. In an embodiment, the aerogel is for use as an infrared shield. In another embodiment, the aerogel is for use in a sensor. In an embodiment, the absorbent is for use in environmental remediation such as oil contaminant removal. In another embodiment, the absorbent is for use in biomedical applications. In another embodiment, the aerogel is for use as an insulation layer in a stress/strain sensor.

The following are non-limiting examples of the present disclosure:

### EXAMPLES

### Example 1: Superelastic and Ultralight Aerogel Assembled from Hemp Microfibers

Aerogels with both high elastic strain and fast shape recovery after compression have broad applications, for example, in thermal regulation, absorbents, and/or in electrical devices. However, creating such materials from cellulosic materials can require complicated preparation processes. The present example reports a simple strategy for scalable production of hemp microfibers using a top-down method, which can further be assembled into aerogels with interconnected porous structures via an ice-templating technique. With density as low as 2.1 mg cm⁻³, the exemplary aerogels reported herein demonstrate isotropic superelasticity, as exhibited by their fast shape restoration from over 80% compressive strain. Due to the high porosity (99.87%) and structural tortuosity, these aerogels showed a low thermal conductivity of 0.0215±0.0002 W m⁻¹ K⁻¹, suggesting their potential in thermal insulation applications. Hydrophobic modification using silane derivative further endowed the exemplary aerogels with reduced water affinity. Overall, the proposed strategy to prepare bio-based microfibers using scalable technology, as well as the assembled aerogels, provides new insights into the design and fabrication of multifunctional bio-based materials for value-added applications.

### I. Experimental Section/Methods

Materials: Hemp stalks harvested in Vancouver, Canada, were kindly provided by SynerGenetics Bioscience Inc, and the bast was manually peeled from the stalk. Polyamide-epichlorohydrin (PAE), with commercial name of Kymene™ 557H, was obtained from Solenis, DE, USA and stored at 4° C. Sodium chlorite (NaClO₂, ACS grade) was purchased from Sigma Aldrich. Acetic acid (ACS grade), sodium acetate (ACS grade, ≥99.0%), methyltrimethoxysilane (MTMS, 97%), hexadecane (99%), toluene (ACS grade), hexanes (mixture of isomers, ≥98.5%), acetone (≥99.9%), tetrahydrofuran (≥99.0%), dimethyl sulfoxide (DMSO, ACS grade) and chloroform (≥99.8%) were purchased from Thermo Fisher Scientific. Silicone oil was purchased from a local retailer. Deionized (DI) water was generated using a Barnstead Mega-Pure Glass Stills (Thermo Fisher Scientific) and used throughout the experiments. All reagents were used without further purification.

Delignification of hemp fibers: The hemp bast fibres were firstly immersed in hot water (100° C.) then left to cool down overnight. The water soaked hemp bast fibers (15 g) were further treated with a 1.7 wt % NaClO₂ solution (500 mL) and buffered with acetic acid solution (0.06 mmol L¹) at pH 4.6 at 80° C. for 5 h. The delignified hemp fibers were then washed with copious DI water and dried at ambient conditions.

Fabrication and surface modification of hemp aerogel: Hemp microfiber suspensions were obtained by mechanical blending (Vitamix 5200, 15 min) of the delignified hemp fibers. After blending, 1 wt % PAE (with respect to hemp) was added into the suspension. Then the hemp microfiber suspension was diluted to various concentrations of 0.1%, 0.2%, 0.5%, 0.8%, 1.0%, 1.5% and 2%. The suspended hemp microfibers were frozen at −20° C. and then freeze-dried to obtain the aerogel. The aerogels were then heated in a vacuum oven at 120° C. for 3 h to complete the cross-linking process. The obtained aerogels were hydrophobized by chemical vapor deposition of MTMS in a sealed container (containing 1 mL MTMS and 0.5 mL water) at 80° C. for 6 h.

Characterization: The chemical structures of samples were observed through FTIR (Bruker Optics). The zeta potential was measured without ionic strength adjustment by a Zetasizer Nano S90 (Malvern Instrument). Crystallinity information of samples was determined by XRD analysis (Bruker, Billerica). The crystallinity index (CrI) was calculated based on the Segal empirical equation (Beluns et al., 2021). Morphologies of hemp fibers and assembled aerogels were visualized by Polarized optical microscopy (POM; POLYVAR) and Scanning Electron Microscope (SEM, Helios NanoLab 650 FIB-SEM). Thermal conductivity and diffusivity of the aerogels were determined by a thermal conductivity analyzer (TPS 2500 S) at ambient condition. Infrared images were taken using a handheld IR Thermal Imaging camera (RoHS HT-19). The water contact angle was quantified using Theta Flex (Biolin Scientific). Chemical compositions of hemp bast and delignified fibers was analyzed using TAPPI standard T-22 om-88 method. The acid-insoluble lignin (AIL) content was weighted out using fritted glass crucible and the acid-soluble lignin (ASL) was measured by the absorbance at 205 nm. The result composition content was determined by HPLC (ICS-3000). The compression experiments were tested using an Instron (5969 Uniaxial Materials Testing System). Cylindrical aerogels (diameter: 21±0.3 mm, height: 25±0.8 mm) were compressed to a strain of 40% in vertical direction for 100 times. Cuboid aerogel (Thickness: 12±0.3 mm, width: 18±0.2 mm, height: 24±0.5 mm) were compressed to a strain of 40% along transverse direction for 100 times.

### II. Results and Discussion

To prepare cellulosic aerogel with microscale fibrous continuity, a top-down strategy may represent a scalable and commercially competitive option. An ideal building block can be a type of cellulosic microfiber with high aspect ratio and abundant defibrillated microfibers. When made into monolithic aerogels, the microfibers would lead to the formation of interconnected fibrous cellular walls. The high aspect ratio and robust mechanical strength make hemp fibers stand out among other types of cellulose feedstocks (Shahzad, 2012). Defibrillating hemp fibers into required dimensions through chemical or mechanical treatment may offer a potential candidate for preparing superelastic cellulosic aerogels. Specifically, robust hemp microfibers with high tolerance to shear force can maintain their high aspect ratio during mechanical treatment, while nanofibers can be generated along the microfibers, both being beneficial to generating sufficient entanglement between microfibers when assembling into aerogel. Compared with the previously mentioned methods such as electrospinning and dual ice templating, this strategy involves only the use of mechanical treatment and is expected to be facilely scalable. In addition, the continuous fibrous structure can substantially improve material utilization, holding great promise as an exceptional building block for constructing superelastic aerogels with a connected network.

### (a) Fabrication of Superelastic Aerogels

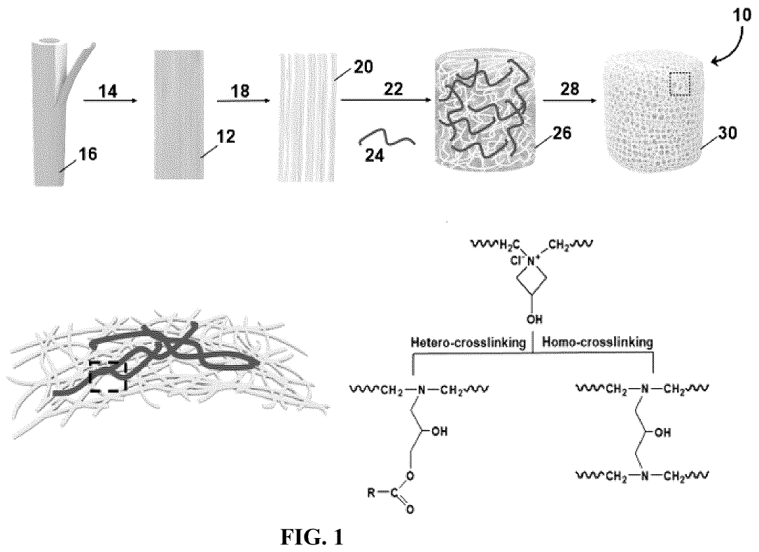

It has been previously shown that, in order to achieve superelasticity, the cell wall of cellulosic aerogel should have an open-mesh structure that is formed by continuous interconnected sub-micron or microfibers (Qin et al., 2021). In this study, the continuous microfibers are isolated from bulk hemp bast fibers via a top-down approach, and by controlling the fiber concentration, cell walls with an open-mesh like structure can be obtained by ice templating and freeze-drying. An exemplary synthesis pathway 10 of hemp aerogel is displayed in FIG. 1. In the exemplary synthesis depicted as the upper schematic in FIG. 1, hemp bast fibers 12 were chosen as the raw material to construct the elastic fibrous network due to the long fiber morphology. The original hemp bast fiber 12 was firstly peeled off 14 from the stalk 16, followed by a delignification 18 to obtain a delignified sheet 20 and defibrillation comprising a high-speed mechanical blending process 22 to form the microfiber suspension (not shown). After adding an in-situ crosslinking agent polyamide-epichlorohydrin (PAE, 24), the well-dispersed microfiber suspension 26 was frozen and then freeze dried 28 into the aerogel and finally heated (not shown) to fully crosslink the microfibers with PAE in the aerogel 30 thereby obtained. The schematic in the lower left of FIG. 1 is a schematic depicting the microfibers crosslinked with PAE in the area enclosed by the rectangle in the aerogel 30 in the upper schematic of FIG. 1. The schematic in the lower right of FIG. 1 is a schematic depicting exemplary hetero-crosslinking and homo-crosslinking of PAE at the area enclosed by the rectangle in the schematic in the lower left of FIG. 1.

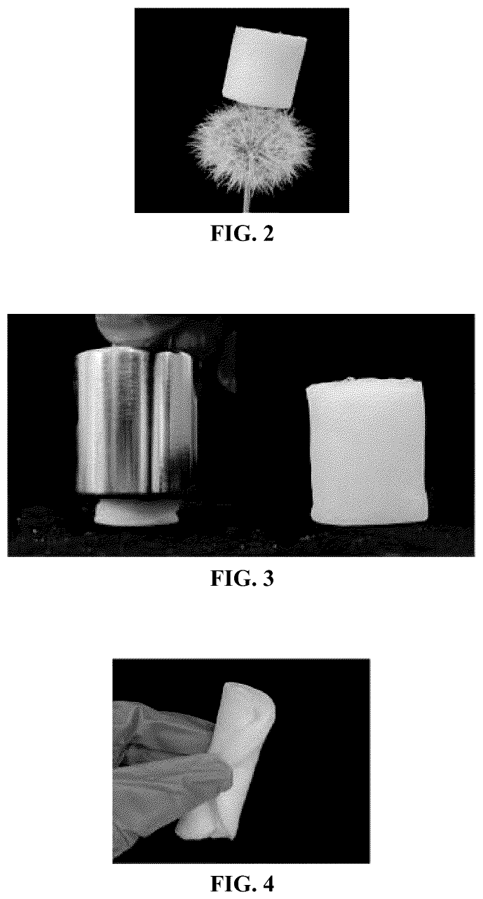

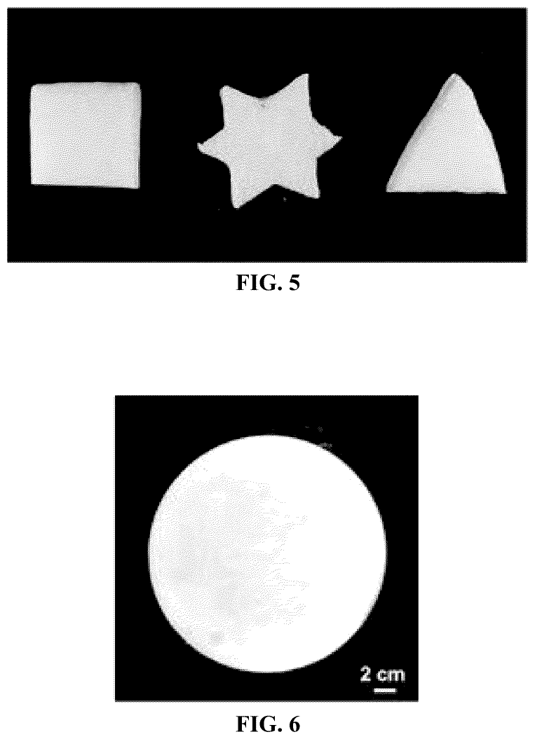

Particularly, the freezing process was governed by complex and dynamic water-fiber, and fiber-fiber interactions, where microfibers in the dispersion accumulated between the growing ice crystals. The densities of the aerogels can be manipulated by changing the concentration of the microfiber suspensions from 1.5 to 21 mg cm⁻³. The hemp-based aerogel (with density of 2.1 mg cm⁻³) produced were found to be ultralight, superelastic (shape recovery after high strain compression), and flexible, as shown in FIG. 2, FIG. 3 and FIG. 4, respectively. Due to the use of ice templating, the materials can be prepared into various shapes depending on the mold used (FIG. 5). In addition, the aerogel can be easily scalable, as shown by the successful fabrication of a large piece of aerogel with 22 cm in diameter and 2 cm in thickness (FIG. 6).

### (b) Hemp Fibers Morphologies and Suspension Properties

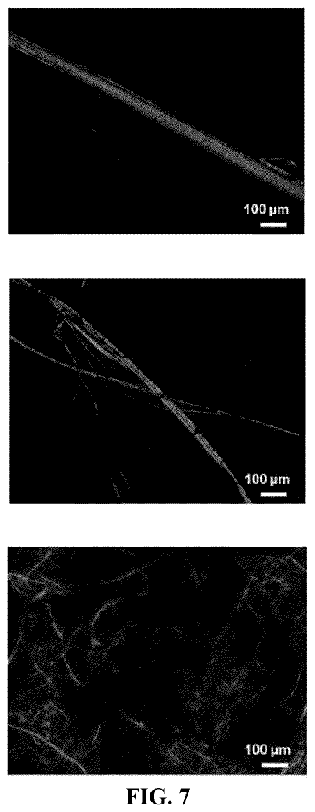

The morphology of hemp bast fibers before and after treatment were characterized by polarized optical microscopy (FIG. 7). After delignification, the hemp fiber bundle was liberated from the hemp bast fiber at a yield of 78.7%, which can be further fragmented into short microfibers by high-speed mechanical blending. The chemical compositions of hemp bast and delignified hemp fibers are given in Table 1.

TABLE 1
Cellulose, hemicellulose and lignin content of the hemp bast fibers and delignified fibers.

| | | Hemicellulose (%) | | | | Lignin (%) | | |
|---|---|---|---|---|---|---|---|---|
| | Cellulose (%) | Arabinan | Galactan | Xylan | Mannan | AIL | ASL | Total |
| Bast fiber | 46.7 | 0.8 | 1.5 | 4.5 | 4.4 | 7.2 | 1.59 | 8.79 |
| Delignified fiber | 76.5 | 0.1 | 0.3 | 6.0 | 5.3 | 3 | 1.14 | 4.14 |

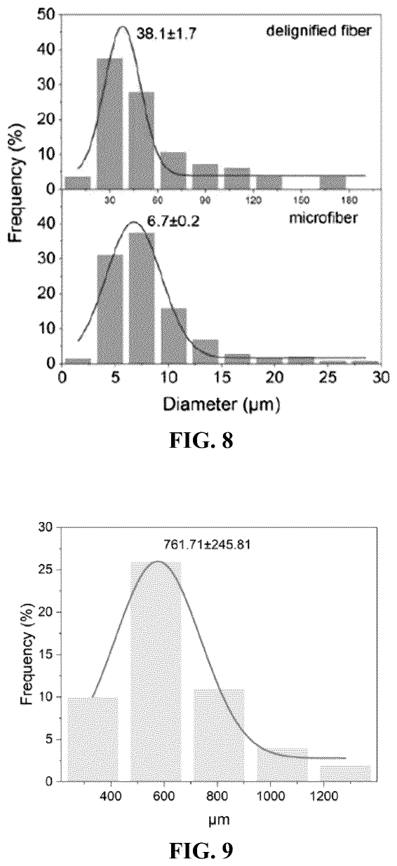

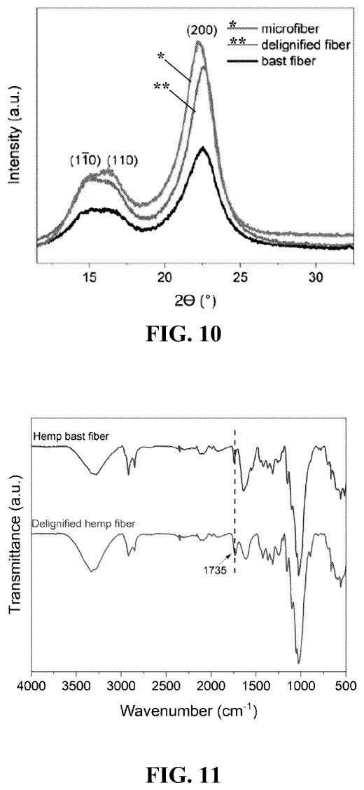

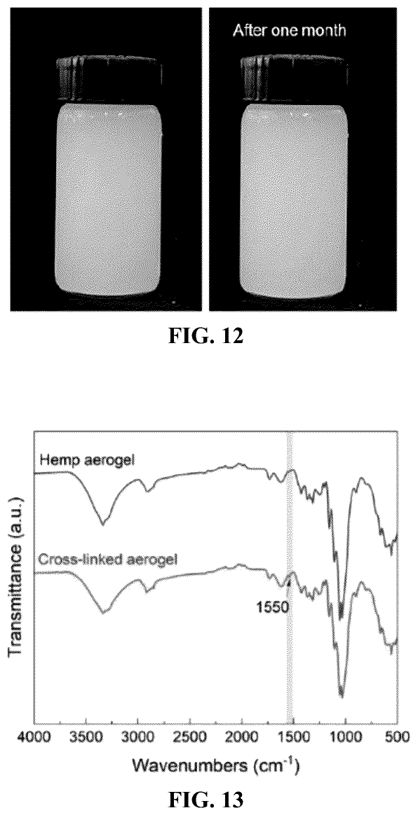

NaClO₂ treatment progressively removed lignin (50%), while kept the hemicellulose content almost unchanged. Due to the removal of non-cellulosic components, the cellulose content increased after delignification. FIG. 8 demonstrated that the lateral dimensions of the fiber greatly changed after blending. Apparently, most of the microfibers possessed a peak diameter of around 6.7 μm, much smaller than that of the delignified hemp fibers (around 38.1 μm). The average length of microfiber was 761 μm (FIG. 9). Thus, the aspect ratio of hemp microfiber was around 110, proving that robust hemp fibers can maintain their high aspect ratio during mechanical treatment. XRD was used to examine the crystallinity of the samples by different treatments (FIG. 10). A major diffraction peak for 2θ ranging between 22 and 23° is attributed to the (200) crystallographic planes of cellulose Iβ. The other two peaks were found at 15.2° and 16.6°, corresponding to (11̅0) and (110) crystallographic planes of cellulose Iβ, respectively (Jiang and Hsieh, 2013). Hemp bast fibers exhibited a crystallinity index of 68%. In contrast, delignified hemp fibers gave a higher crystallinity index of 74%, which can be attributed to the removal of non-cellulosic components. Further mechanical blending appeared to barely change the crystallinity of the hemp microfiber, as indicated by a similar XRD profile and a similar crystallinity index of 73%. The zeta potential of the hemp microfiber suspension was found to be −30.3±3.8 mV, which is close to the microfluidizer derived nanocellulose from alkaline treated hemp, and the negative charges are deemed to be from the carboxylate groups in the remaining hemicellulose in the cell walls (Beluns et al., 2021). This can be further confirmed by the FTIR (FIG. 11). The peak at 1735 cm⁻¹, which is commonly related to the stretching vibration of carbonyl groups in hemicellulose (Sawpan et al., 2011; Jiang et al., 2021), is still prominent after NaClO₂ treatment. Such strong electrostatic repulsion of the negatively charged functional groups of hemp microfibers contributed to the colloidal stability of the suspension, as indicated by no gravity sedimentation of the suspension after one month (FIG. 12).

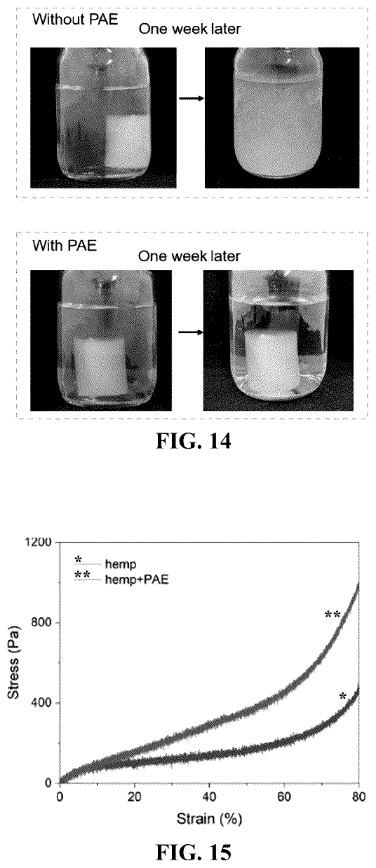

To enhance the bonding between hemp microfibers and improve the mechanical stability of the assembled aerogel, PAE was introduced into the system as an in-situ crosslinking agent at a low dosage of 1 wt % with respect to hemp microfibers. Previous studies have revealed that PAE can trigger both homo-crosslinking and hetero-crosslinking (Zhang et al., 2012; Obokata and Isogai, 2009). PAE can act as a wet strength enhancement by forming covalent ester bonds between carboxyl groups of hemp microfibers and azetidinium groups of PAE. Also, the azetidinium groups and secondary amines of PAE can develop into water-insoluble networks during heating. These self-crosslinking networks play a vital role in supporting the structure by inhibiting fiber-bond detachment when being re-wetted in water and so improving the wet strength and structural integrity. FTIR analysis (FIG. 13) confirmed the introduction of PAE. The main difference between two is the presence of a new peak at 1550 cm⁻¹ (shadowed in light grey), which is attributed to the —NH groups of the PAE cross-linker (Sharma and Deng, 2016). When immersed in water, the PAE-strengthened hemp aerogel maintained its structural integrity, overcoming water-induced swelling and structural collapse (FIG. 14). In addition, adding PAE roughly doubled the aerogel's compressive stress as compared to that of PAE-free aerogel under 80% strain (FIG. 15).

### (c) Characterization of Aerogel's Superelasticity

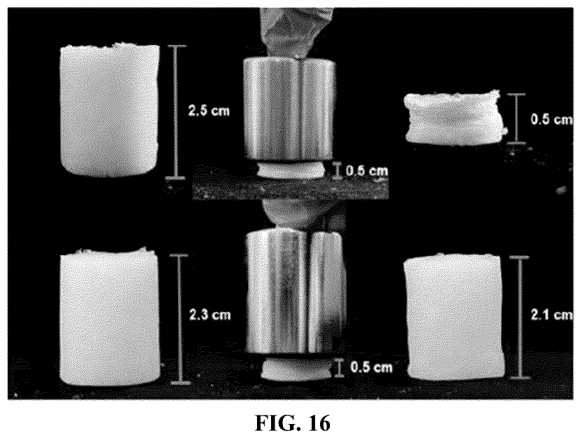

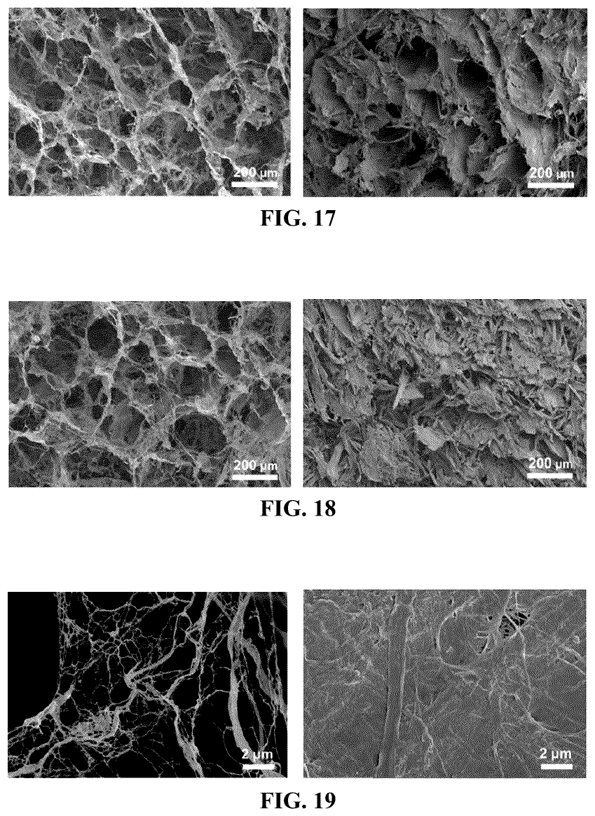

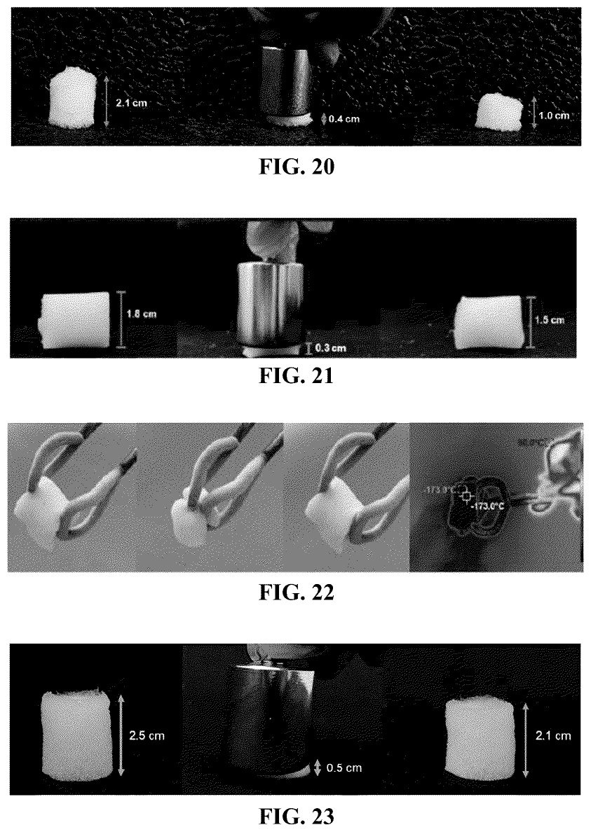

Preliminary tests found that the hemp aerogel's elasticity is directly associated with its apparent density. Compared to the aerogel with higher density (21 mg cm⁻³, FIG. 16, upper images) that cannot recover its original shape after compression, the aerogel with a low density of 2.1 mg cm⁻³ (FIG. 16, lower images) is able to recover to its original shape. Insight into what happened to the aerogel's microscale structure during compression is given by SEM images. Before compression, both aerogels showed a honeycomb structure with a major cellular pore size of around 200 μm (FIG. 17). However, only the ultralow density one (2.1 mg cm⁻³) preserved the honeycomb structure after compression, while the majority of the cellular structures were damaged for the denser aerogel (FIG. 18). Such density-dependent superelasticity can be explained by the difference in their cell wall structures. Unlike the compact cell wall with all fibers stacked together in the denser aerogel (FIG. 19, right image), the cell walls of the lighter aerogel, which consisted of an inter-connected hemp microfiber network, exhibited porous, highly bonded, and fiber-entangled structures (FIG. 19, left image). As noted previously, such unique fibrous cell walls gain stronger structural resistance and undergo elastic deformation under compression, resulting in superelasticity of the corresponding aerogels. However, it should be noted that the 0.1 wt % aerogel (with density of 1.5 mg cm⁻³) showed poorer elasticity (FIG. 20) as compared to the 0.2 wt % aerogel, which could be due to limited microfiber entanglement at such low microfiber concentration. More importantly, since the hemp aerogel was prepared under isotropic freeze-drying conditions, it exhibited superelasticity in all directions, i.e., good shape recovery after compression release regardless of the direction of the applied force (FIG. 21). Such isotropic superelasticity makes the hemp aerogel distinctive from other aerogels that only show superelasticity in a particular direction (Zhang et al., 2019; Yan et al., 2021). Moreover, the hemp aerogel's isotropic superelasticity was found to be well preserved even in an extremely cold environment, for example, −173° C. (FIG. 22). In addition, the addition of PAE makes no observable contribution to the superelastic property. The result showed aerogel without PAE still preserved superelastic properties (FIG. 23), confirming that the superelasticity is originated from the interconnected fibrous structure within the aerogel.

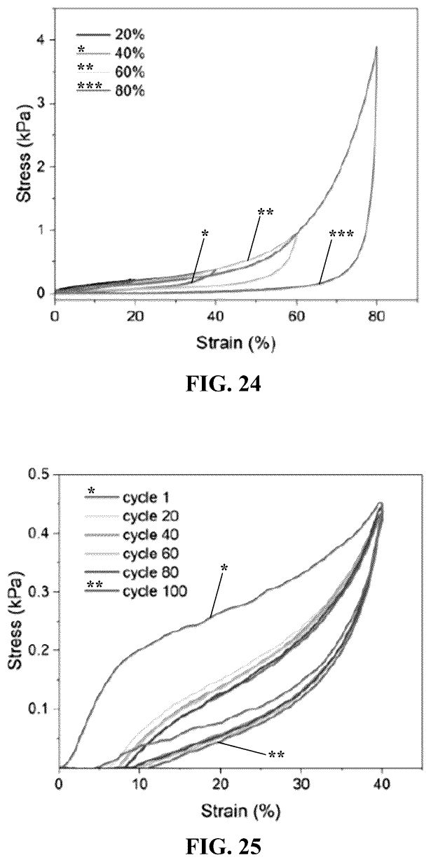

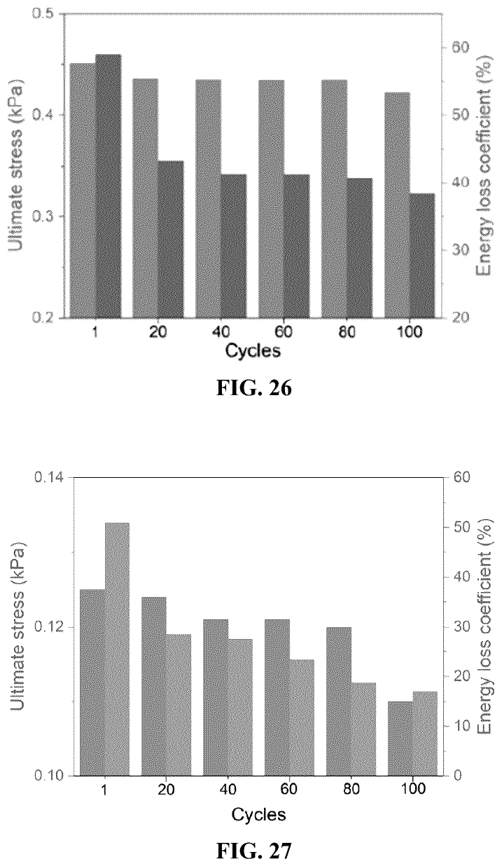

The low-density hemp aerogel's (density of 2.1 mg cm⁻³) mechanical properties were further characterized using a unidirectional compression test. The stress-strain curves (FIG. 24) obtained during compression exhibited three characteristic regions, which is typical for a cellular monolith: a linear elastic range at ε<10%, a subsequent plateau stage at medium strain range (10%<ε<65%), and a densification stage with sharp increase in stress (ε>65%) (Si et al., 2018). The hemp aerogel showed good elastic properties under all different strains, with an increased hysteresis loop under higher strain. The highly elastic aerogel also possessed durable cycling performance. Though certain plastic deformation was observed in the cyclic compression test as shown in the hysteresis curves (FIG. 25), no significant reduction in strength was found for aerogels after the 2nd compression all the way up to 80th cycle. As shown in FIG. 26, hemp aerogels still preserved over 90% of the initial stress, showing good structural integrity. A relatively high energy loss coefficient of 58.9% was found in the first compressive cycle, probably due to the collapse of the less stable or less inter-connected fibers within cell walls. After the first cycle, the energy loss coefficient did not decrease much further until 80th cycle, indicating that the entangled structure can effectively withstand repeated compression. At the 100th cycle, the ultimate stress and energy loss coefficient decreased slightly, which could be ascribed to some structural collapse from repeated compression. Overall, the low-density hemp aerogel exhibits excellent elastic performance under high strain and during cyclic compressive tests. In addition to the vertical direction, the mechanical properties of the aerogel at the transverse direction were also characterized. The ultimate stress (0.125 kPa) is much lower as compared to the vertical direction (FIG. 27), which may suggest some structural anisotropy exists. After 100 cycles of compression tests, the aerogel showed 22% unrecovered strain, and much higher energy loss coefficient as compared to the vertical direction. Nevertheless, the aerogel still maintained good elasticity after 100 cycles of compressive tests.

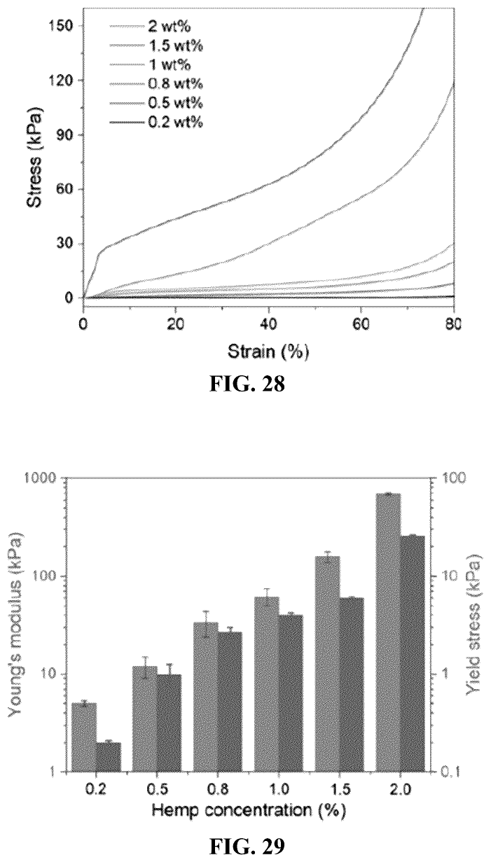

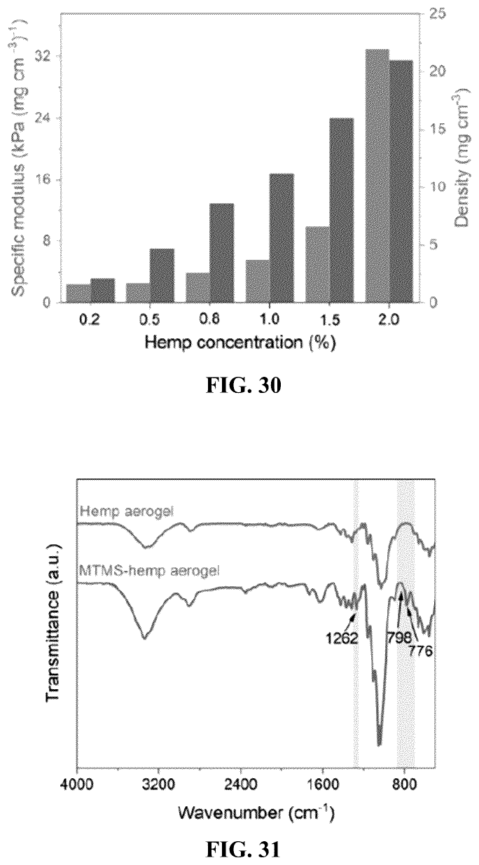

The compressive mechanical performance of aerogels with different apparent densities was investigated as well. Compressive stress-strain curves with varying hemp microfibers concentrations are shown in FIG. 28. All aerogels can be compressed over 80% without cracking, showing superb flexibility. The increased density will lead to more interconnection between adjacent fibers, which results in dramatically increased mechanical performance. The Young's modulus (FIG. 29), yield stress (FIG. 29) and specific modulus (FIG. 30) increased with increasing hemp concentrations, which can be up to 690 kPa, 26 kPa and 32.9 kPa for 2% aerogels, respectively. Therefore, it proves that by simply controlling the initial concentration of hemp microfibers, one can manipulate the aerogels from rigid to superelastic textures.

### (d) Hydrophobic Modification of Hemp Fiber Aerogels

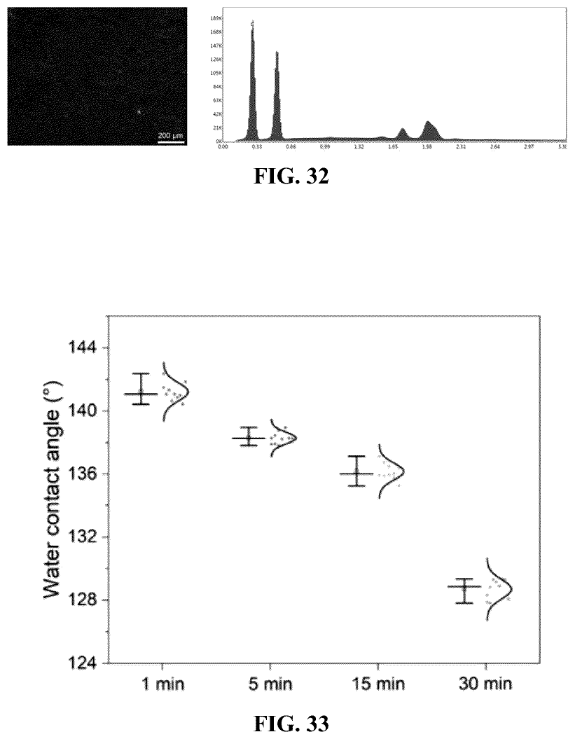

Waterproof properties are an important consideration for all-weather applications of hemp aerogel, particularly to prevent a reduction in its mechanical and thermal insulation performance in high-humidity environments. The hydrophilic nature of hemp microfiber makes it desirable to apply a hydrophobic treatment for enhanced moisture resistance. In this study, the hydrophobic modification was achieved by chemical vapor deposition of methyltrimethoxysilane (MTMS) onto hemp aerogel, which resulted in a uniform hydrophobic coating throughout the aerogel. Successful silane coating was confirmed by FTIR (FIG. 31), showing characteristic peaks at 1262 cm⁻¹, 776 cm⁻¹, and 798 cm⁻¹ (shadowed in light grey), which corresponded to the formation of Si—CH₃ and Si—O—Si bonds (Qin et al., 2021). The presence of Si element can be clearly observed from the EDX mapping image, showing homogenous coverage on the modified aerogel, and the weight concentration of Si was determined at 5.33%, the weight concentration of C was determined at 35.4% and the weight concentration of O was determined at 23.68% (FIG. 32).

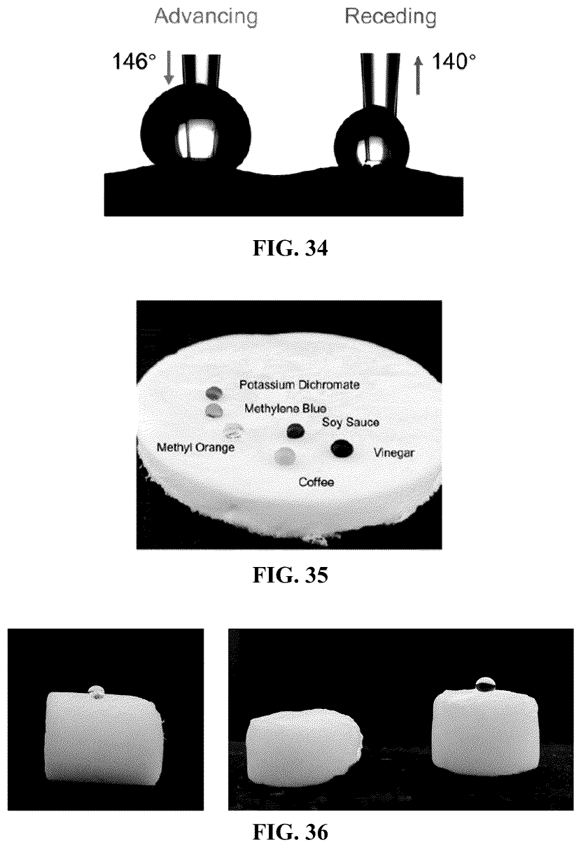

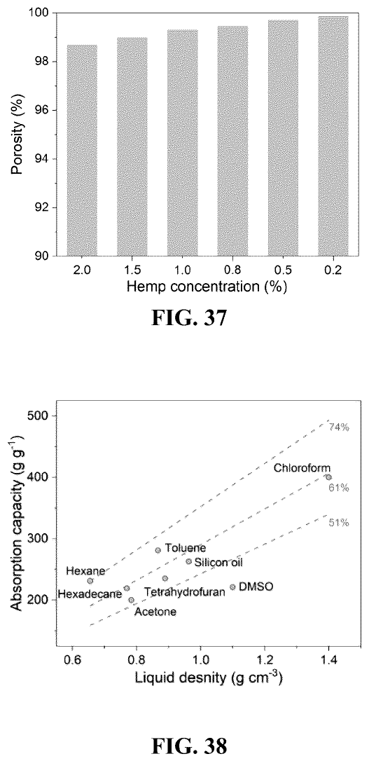

The improved hydrophobicity of the MTMS treated aerogel was confirmed by water contact angle analysis. FIG. 33 showed the change in water contact angle (CA) within 30 min. After modification, the surface was repellent towards water, with a static CA of 142°, and a contact angle hysteresis θₛ of 5±3.4° (FIG. 34). It has been demonstrated that such water repellency is applicable to various types of water-based liquids, which all maintained spherical geometries on the aerogel's surface and could not penetrate into the aerogel (FIG. 35). FIG. 35 is a digital photo of colored aqueous solutions of, from top to bottom: potassium dichromate, methylene blue, methyl orange, soy sauce, vinegar and coffee, deposited on MTMS-hemp aerogel surface. Moreover, such hydrophobicity existed not only at the outer surface of the aerogel but also at the inner surface of a torn-apart aerogel (FIG. 36), confirming a homogenous hydrophobic treatment of the chemical vapor deposition method. Due to the deposition of non-polar methyl groups during MTMS treatment, aerogels can selectively absorb non-polar liquids. The aerogel can absorb and remove soybean oil (dyed by Nile red) from water, suggesting that this aerogel can be used for oil-water separation purposes as well. Due to the high volumetric porosity of aerogels up to 99.87% (FIG. 37), the silane-modified superelastic aerogel exhibited excellent absorption capacities, ranging from 200 to 400 g g⁻¹ (shown in FIG. 38), toward a wide range of oils and organic solvents. For aerogel with larger pore volume, the theoretical absorption capacity mainly depends on the pore volume and can be calculated by Equation (1), by assuming all air-occupied pores can be filled by the liquid (Jiang and Hsieh, 2014):

$$Theoretical absorption capacity = porosity \times \frac{{ρ}_{liquid}}{{ρ}_{aerogel}} \qquad ( 1 )$$

For the case of silane-modified hemp aerogel, it was found that around 67% of the pore volume was responsible for absorbing non-polar liquids. The rest of the unfilled pores are considered un-accessible to liquids or trapped by air. While for more polar liquids, like acetone and dimethyl sulfoxide (DMSO), only around 51% of the calculated pore volume was occupied, which was less than that of non-polar liquids. This can be attributed to the improved hydrophobicity of the MTMS modified aerogels.

The compression-recovery resilience of the hemp microfiber aerogel gives it the ability to cyclically absorb and desorb liquid; results are summarized in FIG. 39. For each cycle, the aerogel was allowed to absorb a maximum amount of hexane, which was then squeezed by hand to release the absorbed solvent. It can be seen that the absorption capacity exhibited a slight decrease after the initial several cycles and then plateaued at around 169 g g⁻¹, which was about 70% of the initial absorption capacity. This can be attributed to the good stability of the well-bonded fibrous structure. The results showed that the aerogel maintained good recyclability for cyclic usages in oil removal.

### (e) Thermal Insulating Properties of Hemp Aerogel

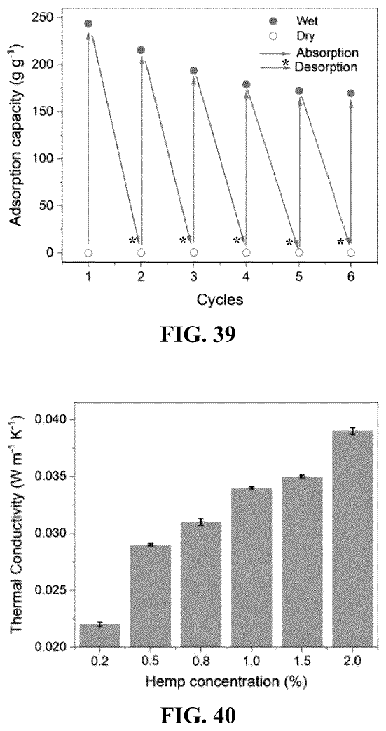

Due to the high porosity, the ultralow density hemp aerogel represents a promising candidate for thermal insulation applications. As shown in FIG. 40 the hemp aerogel (0.2 wt %) had an ultralow thermal conductivity of 0.0215±0.0002 W m⁻¹ K⁻¹, which is even lower than that of air (0.025 W m⁻¹ K⁻¹). This kind of low thermal conductivity was comparable to other reported cellulose-based thermal insulation aerogels (Table 2).

TABLE 2
Comparison of thermal conductivity with previously
reported cellulose-based aerogels.

| Thermal conductivity | | |
|---|---|---|
| (W m⁻¹K⁻¹) | Material(s) | Reference |
| 0.0255 | CNF | Gupta et al., 2018 |
| 0.029-0.032 | recycled cellulose | Nguyen et al., 2014 |
| 0.026 | cellulose-SiO₂ | Shi et al., 2013 |
| 0.023 | polyimide/bacterial | Zhang et al., 2020 |
| | cellulose | |
| 0.023 | CNF | Qin et al., 2021 |
| 0.0215 | hemp | this work |

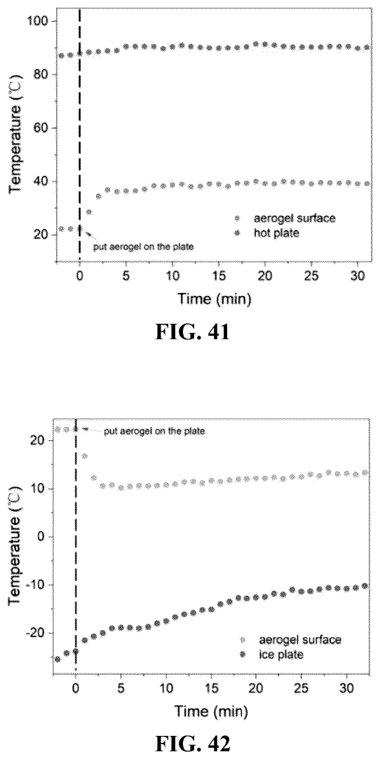

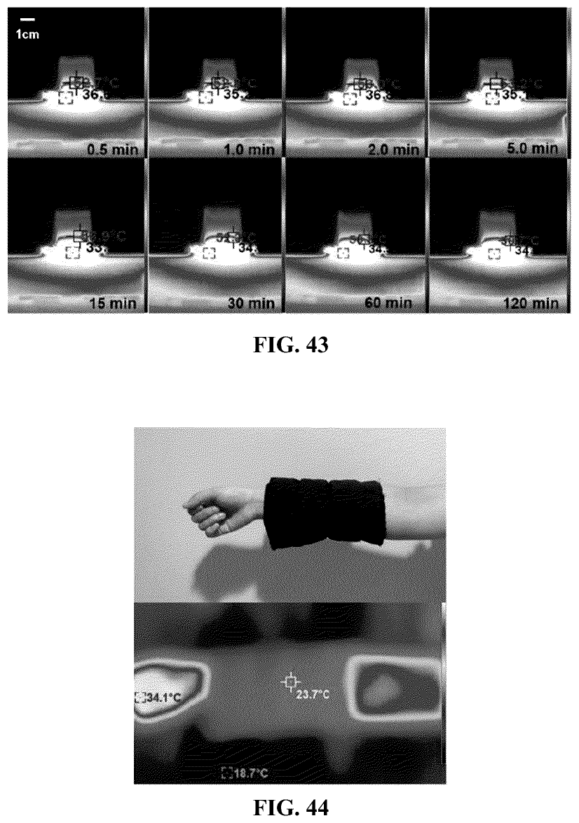

We attributed this result to the high porosity of the aerogel (99.87%, FIG. 37). With further decreased hemp microfibers concentration to 0.1 wt %, the assembled 0.1 wt % hemp aerogel showed thermal conductivity of 0.0259±0.002 W m⁻¹ K⁻¹. This may be due to the loose structure and large pores of the aerogel, leading to large contribution of the air convection. Thus, hemp aerogel with concentration of 0.2 wt % was chosen as the thermal insulation material. The thermal insulation performance of the ultralight aerogel was demonstrated by placing the aerogel on either a hot (80° C.) or cold (−20° C.) plate. After a slight change within the first 3 minutes, the upper temperature of the aerogel stabilized. Notably, the aerogel was able to maintain a consistent 51° C. (FIG. 41) and 23° C. (FIG. 42) temperature difference for the hot and cold scenarios, respectively, suggesting good thermal insulation performance. An Infrared (IR) camera was also used to reveal the thermal insulation properties of the aerogel. FIG. 43 shows the IR image to visualize the process of heat transfer through aerogel. After placing the aerogel on an 80° C. hot plate, heat transfer through the bottom surface can be observed at the first 0.5 min. However, the heat penetration depth did not further increase within 120 min, suggesting effective thermal insulation performance.

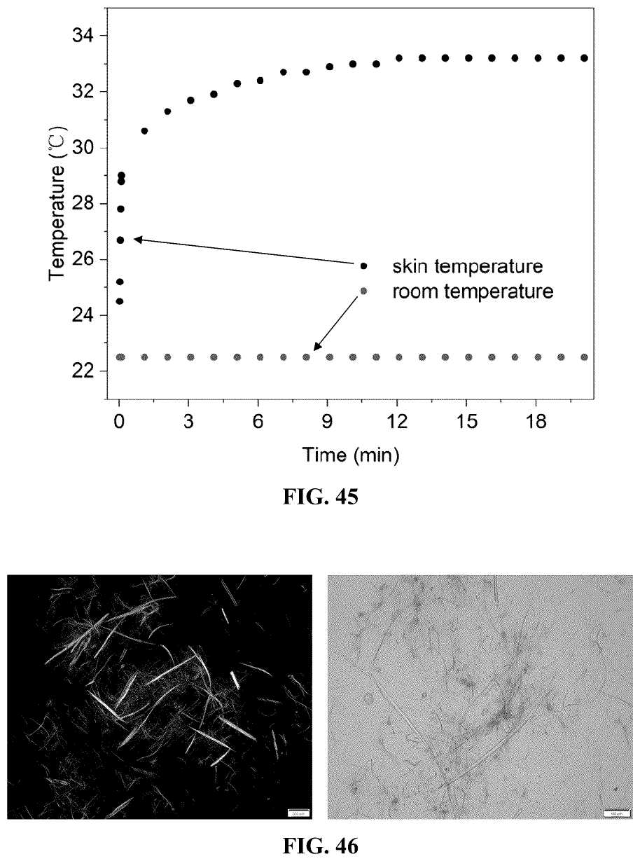

Due to good thermal insulation and superelastic properties, the hemp aerogel developed in this study has considerable potential to be used, for example, as a filler in winter jackets. The ultralow density aerogels can fit in fabric, and the flexibility endows them to bend into different angles (FIG. 44). As shown in the IR photo, the covered area mitigated heat loss from the body and showed a temperature similar to the background environment, compared to the uncovered forearm showing a typical skin temperature value. The temperature change within fabric was also measured (FIG. 45). The fabric shows an excellent warmth-retention effect and the temperature of the skin covered by the fabric increased significantly in few seconds. Also, the fabric can effectively inhibit temperature exchange between skin to room temperature, allowing a constant 11° C. temperature difference between the two.

### III. CONCLUSION

In summary, we demonstrated a simple and effective way to make long microfibers from hemp bast fibers through a top-down method. Such long microfibers can be further assembled into aerogels with interconnected fibrous architectures. The resulting aerogel offers high porosity (99.87%) and low density (2.1 mg cm⁻³) yet mechanical durability and superelasticity. Consequently, the hemp aerogel showed shape recovery under high strain and achieved 92.5% strength retention after 60 loading-unloading cycles. Such superelasticity can still be preserved under an extremely cold environment. In addition, the aerogel showed excellent thermal insulation properties, with measured thermal conductivity as low as 0.0215±0.0002 W m⁻¹ K⁻¹. With their ultralow density, temperature invariant superelasticity, low thermal conductivity, and hydrophobicity, this kind of aerogel will open broad technological applications, for example, in thermal insulation, absorbents, and/or flexible electrical devices. The preparation process of the hemp aerogel proposed in this example can be adopted to valorize other types of natural fibers to fabricate bio-based aerogels with lightweight and superelasticity for insulation purposes.

### Example 2

### I. Materials and Methods

After undergoing tempo oxidation and 20 minutes of mechanical blending, cellulose nanofibrils (CNF) were obtained in a uniform dispersion. To obtain microfibrillated cellulose sample MFC1 Northern bleached softwood kraft (NBSK) suspension with a concentration of 5.0 wt % was fibrillated through a Supermass Colloider (MKCA6-5J, Masuko, Japan), a disc grinder, at 1500 rpm. The gap distance between the grinding stones was adjusted to −50 μm and passed 10 times. To prevent clogging of fibers in the grinder, the suspensions were sequentially passed grinder with gaps of +600 μm, +300 μm, +200 μm, +150 μm, +100 μm, +50 μm, +20 μm, +10 μm, 0 μm, and −20 μm for 8 times at each gap before passing the gap of −50 μm. The concentration of the final obtained MFC1 slurry was 2.23 wt %. Microfibrillated cellulose sample MFC2 was obtained after mechanical blending of MFC1 for a duration of 10 minutes. Delignified hemp fiber suspension was prepared after 16 minutes of mechanical blending. All samples were prepared at a concentration of 0.2 wt %. Subsequently, ice templating at −18° C. followed by freeze-drying was used to prepare aerogels in line with the procedures described in Example 1.

### II. Results and Discussion

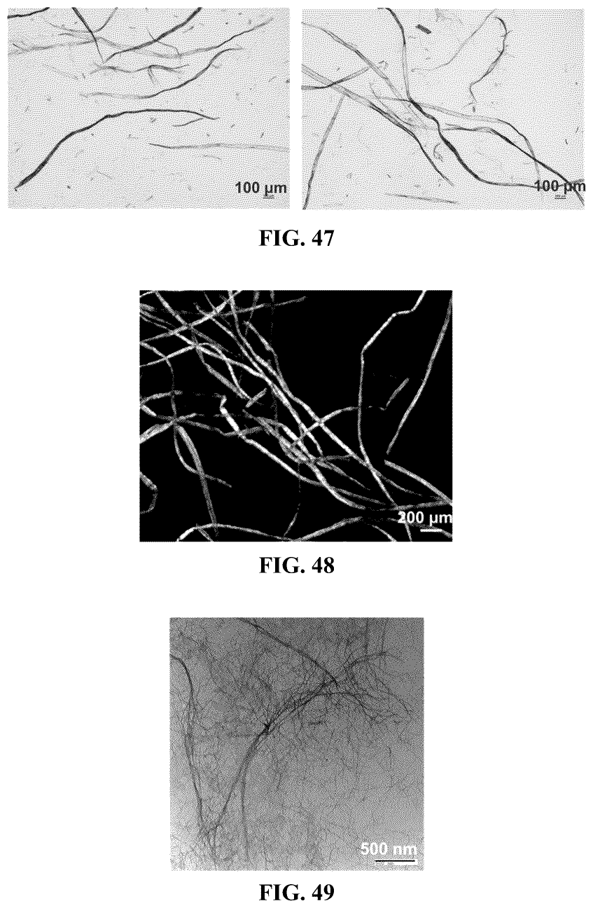

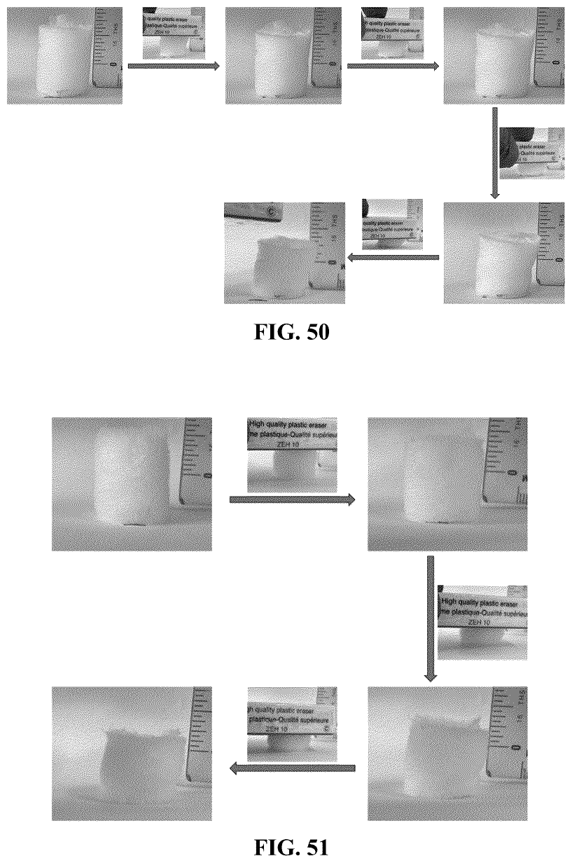

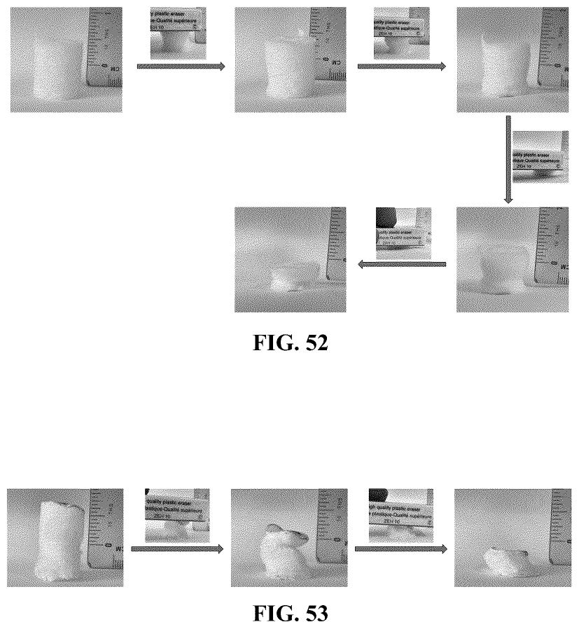

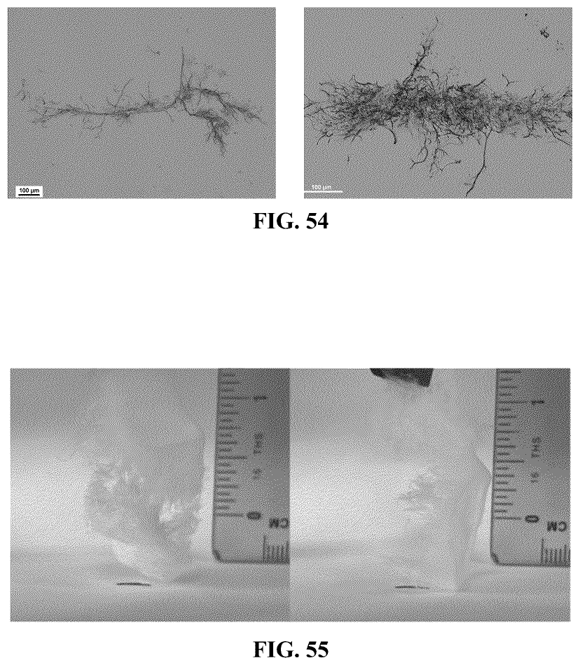

Microscope images of the hemp fiber suspension displayed the presence of larger fibers measuring around 7 micrometers and small fibers in the range of a few hundred nanometers, resulting in an aspect ratio of approximately 110 (FIG. 46). For MFC1, the size was about 36 micrometers, with an aspect ratio of about 56 (FIG. 47). As for NBSK pulp, the diameter was approximately 40 micrometers, and the aspect ratio was about 60 (FIG. 48). In contrast, CNF exhibited the smallest size, around a few tens of nanometers, with the largest aspect ratio of 264 (FIG. 49). The aerogel derived from hemp fiber exhibited the best elastic performance (FIG. 50), followed by MFC1 (FIG. 51) and NBSK pulp (FIG. 52) which had similar elastic performance compared to each other, while CNF showed the least favorable performance (FIG. 53). After the extended mechanical processing, MFC2 had a reduced size in comparison to MFC1 with a diameter of approximately 10 micrometers (FIG. 54). However, it failed to form an aerogel after freeze-drying (FIG. 55). The aspect ratio of MFC2 was not measured due to the agglomeration of the fibers but the fibers appeared to be much shorter than the fibers of the MFC1 sample. While not wishing to be limited by theory, the shorter fiber length leads to low aspect ratio, which can limit the fiber interaction during ice templating.

### FULL CITATIONS FOR REFERENCES REFERRED TO IN THE DESCRIPTION

Ahankari, S.; Paliwal, P.; Subhedar, A.; Kargarzadeh, H. Recent Developments in Nanocellulose-Based Aerogels in Thermal Applications: A Review. Acs Nano 2021, 15 (3), 3849-3874. DOI: 10.1021/acsnano.0c09678.
Apostolopoulou-Kalkavoura, V.; Munier, P.; Bergstrom, L. Thermally Insulating Nanocellulose-Based Materials. Advanced Materials 2021, 33 (28). DOI: 10.1002/adma.202001839.
Beluns, S.; Gaidukovs, S.; Platnieks, O.; Gaidukova, G.; Mierina, I.; Grase, L.; Starkova, O.; Brazdausks, P.; Thakur, V. K. From Wood and Hemp Biomass Wastes to Sustainable Nanocellulose Foams. Industrial Crops and Products 2021, 170. DOI: 10.1016/j.indcrop.2021.113780.
Cuce, E.; Cuce, P. M.; Wood, C. J.; Riffat, S. B. Toward aerogel based thermal superinsulation in buildings: A comprehensive review. Renewable & Sustainable Energy Reviews 2014, 34, 273-299. DOI: 10.1016/j.rser.2014.03.017.
Ferreira, E. S.; Rezende, C. A.; Cranston, E. D. Fundamentals of cellulose lightweight materials: bio-based assemblies with tailored properties. Green Chemistry 2021, 23 (10), 3542-3568. DOI: 10.1039/d1gc00326g.
Gupta, P.; Singh, B.; Agrawal, A. K.; Maji, P. K. Low density and high strength nanofibrillated cellulose aerogel for thermal insulation application. Material Design 2018, 158, 224-236. DOI: 10.1016/j.matdes.2018.08.031.
Huang, J. K.; Zeng, J. B.; Zhang, X.; Guo, G. C.; Liu, R.; Yan, Z. F.; Yin, Y. D. Fatigue Resistant Aerogel/Hydrogel Nanostructured Hybrid for Highly Sensitive and Ultrabroad Pressure Sensing. Small 2022, 18 (1). DOI: 10.1002/smll.202104706.
Jiang, F.; Hsieh, Y.-L. Chemically and mechanically isolated nanocellulose and their self-assembled structures. Carbohydrate Polymers 2013, 95 (1), 32-40. DOI: 10.1016/j.carbpol.2013.02.022.
Jiang, F.; Hsieh, Y. L. Amphiphilic superabsorbent cellulose nanofibril aerogels. Journal of Materials Chemistry A 2014, 2 (18), 6337-6342. DOI: 10.1039/c4ta00743c.
Jiang, F.; Hsieh, Y. L. Dual Wet and Dry Resilient Cellulose II Fibrous Aerogel for Hydrocarbon-Water Separation and Energy Storage Applications. ACS Omega 2018, 3 (3), 3530-3539. DOI: 10.1021/acsomega.8b00144.
Jiang, J. G.; Zhu, Y. L.; Zargar, S.; Wu, J.; Oguzlu, H.; Baldelli, A.; Yu, Z. Y.; Saddler, J.; Sun, R. C.; Tu, Q. S.; et al. Rapid, high-yield production of lignin-containing cellulose nanocrystals using recyclable oxalic acid dihydrate. Industrial Crops and Products 2021, 173. DOI: 10.1016/j.indcrop.2021.114148.
Kim, C.; Youn, H.; Lee, H. Preparation of cross-linked cellulose nanofibril aerogel with water absorbency and shape recovery. Cellulose 2015, 22 (6), 3715-3724. DOI: 10.1007/s10570-015-0745-5.
Koebel, M.; Rigacci, A.; Achard, P. Aerogel-based thermal superinsulation: an overview. Journal of Sol-Gel Science and Technology 2012, 63 (3), 315-339. DOI: 10.1007/s10971-012-2792-9.
Liu, J.; Zhang, H. B.; Xie, X.; Yang, R.; Liu, Z. S.; Liu, Y. F.; Yu, Z. Z. Multifunctional, Superelastic, and Lightweight MXene/Polyimide Aerogels. Small 2018a, 14 (45). DOI: 10.1002/smll.201802479.
Liu, J.; Liu, Y. F.; Zhang, H. B.; Dai, Y.; Liu, Z. S.; Yu, Z. Z. Superelastic and multifunctional graphene-based aerogels by interfacial reinforcement with graphitized carbon at high temperatures. Carbon 2018b, 132, 95-103. DOI: 10.1016/j.carbon.2018.02.026.
Mi, H. Y.; Jing, X.; Politowicz, A. L.; Chen, E.; Huang, H. X.; Turng, L. S. Highly compressible ultra-light anisotropic cellulose/graphene aerogel fabricated by bidirectional freeze drying for selective oil absorption. Carbon 2018, 132, 199-209. DOI: 10.1016/j.carbon.2018.02.033.
Nguyen, S. T.; Feng, J.; Ng, S. K.; Wong, J. P. W.; Tan, V. B. C.; Duong, H. M. Advanced thermal insulation and absorption properties of recycled cellulose aerogels. Colloids Surfaces A: Physicochemical and Engineering Aspects 2014, 445, 128-134. DOI: 10.1016/j.colsurfa.2014.01.015.
Obokata, T.; Isogai, A. Wet-strength development of cellulose sheets prepared with polyamideamine-epichlorohydrin (PAE) resin by physical interactions. Nordic Pulp & Paper Research Journal 2009, 24 (2), 135-140. DOI: 10.3183/npprj-2009-24-02-p135-140.
Pierre, A. C.; Pajonk, G. M. Chemistry of aerogels and their applications. Chemical Reviews 2002, 102 (11), 4243-4265. DOI: 10.1021/cr0101306.
Pirzada, T.; Ashrafi, Z.; Xie, W. Y.; Khan, S. A. Cellulose Silica Hybrid Nanofiber Aerogels: From Sol-Gel Electrospun Nanofibers to Multifunctional Aerogels. Advanced Functional Materials 2020, 30 (5). DOI: 10.1002/adfm.201907359.
Qin, Y. Y.; Peng, Q. Y.; Ding, Y. J.; Lin, Z. S.; Wang, C. H.; Li, Y.; Li, J. J.; Yuan, Y.; He, X. D.; Li, Y. B. Lightweight, Superelastic, and Mechanically Flexible Graphene/Polyimide Nanocomposite Foam for Strain Sensor Application. ACS Nano 2015, 9 (9), 8933-8941. DOI: 10.1021/acsnano.5b02781.
Qin, H. F.; Zhang, Y. F.; Jiang, J. G.; Wang, L. L.; Song, M. Y.; Bi, R.; Zhu, P. H.; Jiang, F. Multifunctional Superelastic Cellulose Nanofibrils Aerogel by Dual Ice-Templating Assembly. Advanced Functional Materials 2021, 31 (46). DOI: 10.1002/adfm.202106269.
Qin, Z.; Lv, Y. H.; Fang, X. H.; Zhao, B.; Niu, F. X.; Min, L. Z.; Pan, K. Ultralight polypyrrole crosslinked nanofiber aerogel for highly sensitive piezoresistive sensor. Chemical Engineering Journal 2022, 427. DOI: 10.1016/j.cej.2021.131650.
Qin, B.; Yu, Z. L.; Huang, J.; Meng, Y. F.; Chen, R.; Chen, Z.; Yu, S. H. A Petrochemical-Free Route to Superelastic Hierarchical Cellulose Aerogel. Angewandte Chemie-International Edition. 2023, 62, e202214809 DOI: 10.1002/anie.202214809.
Sawpan, M. A.; Pickering, K. L.; Fernyhough, A. Effect of various chemical treatments on the fibre structure and tensile properties of industrial hemp fibres. Composites Part Applied Science and Manufacturing 2011, 42 (8), 888-895. DOI: 10.1016/j.compositesa.2011.03.008.
Shahzad, A. Hemp fiber and its composites—a review. Journal of Composite Materials 2012, 46 (8), 973-986. DOI: 10.1177/0021998311413623.
Sharma, S.; Deng, Y. L. Dual Mechanism of Dry Strength Improvement of Cellulose Nanofibril Films by Polyamide-epichlorohydrin Resin Cross-Linking. Industrial & Engineering Chemistry Research 2016, 55 (44), 11467-11474. DOI: 10.1021/acs.iecr.6b02910.
Shi, J. J.; Lu, L. B.; Guo, W. T.; Zhang, J. Y.; Cao, Y. Heat insulation performance, mechanics and hydrophobic modification of cellulose-SiO₂ composite aerogels. Carbohydrate Polymers 2013, 98, 282-289. DOI: 10.1016/j.carbpol.2013.05.082.
Si, Y.; Wang, X. Q.; Dou, L. Y.; Yu, J. Y.; Ding, B. Ultralight and fire-resistant ceramic nanofibrous aerogels with temperature-invariant superelasticity. Science Advances 2018, 4 (4). DOI: 10.1126/sciadv.aas8925.
Song, M. Y.; Jiang, J. G.; Qin, H. F.; Ren, X. Y.; Jiang, F. Flexible and Super Thermal Insulating Cellulose Nanofibril/Emulsion Composite Aerogel with Quasi-Closed Pores. ACS Applied Materials & Interfaces 2020, 12 (40), 45363-45372. DOI: 0.1021/acsami.0c14091.
Sun, H.; Xu, Z.; Gao, C. Multifunctional, Ultra-Flyweight, Synergistically Assembled Carbon Aerogels. Advanced Materials 2013, 25 (18), 2554-2560. DOI: 10.1002/adma.201204576.
Wei, G.; Zhang, J. M.; Usuelli, M.; Zhang, X. F.; Liu, B.; Mezzenga, R. Biomass vs inorganic and plastic-based aerogels: Structural design, functional tailoring, resource-efficient applications and sustainability analysis. Progress in Materials Science 2022, 125. DOI: 10.1016/j.pmatsci.2021.100915.
Xu, T.; Wang, Z.; Ding, Y. C.; Xu, W. H.; Wu, W. D.; Zhu, Z. T.; Fong, H. Ultralight electrospun cellulose sponge with super-high capacity on absorption of organic compounds. Carbohydrate Polymers 2018, 179, 164-172. DOI: 10.1016/j.carbpol.2017.09.086.
Xu, X.; Fu, S. B.; Guo, J. R.; Li, H.; Huang, Y.; Duan, X. F. Elastic ceramic aerogels for thermal superinsulation under extreme conditions. Materials Today 2021, 42, 162-177. DOI: 10.1016/j.mattod.2020.09.034.
Yan, M. Y.; Pan, Y. L.; Cheng, X. D.; Zhang, Z. X.; Deng, Y. R.; Lun, Z. Y.; Gong, L. L.; Gao, M. Y.; Zhang, H. P. “Robust-Soft” Anisotropic Nanofibrillated Cellulose Aerogels with Superior Mechanical, Flame-Retardant, and Thermal Insulating Properties. ACS Applied Materials & Interfaces 2021, 13 (23), 27458-27470. DOI: 10.1021/acsami.1c05334.
Yin, S. D.; Zhang, X.; Hu, G. K.; Huang, T.; Yu, H.; Yu, B.; Zhu, M. F. In situ crosslinking of mechanically robust waterproof and moisture permeable cellulose diacetate nanofiber aerogels for warm clothing. Chemical Engineering Journal 2022, 444. DOI: 10.1016/j.cej.2022.136528.
Yu, Z. L.; Yang, N.; Apostolopoulou-Kalkavoura, V.; Qin, B.; Ma, Z. Y.; Xing, W. Y.; Qiao, C.; Bergstrom, L.; Antonietti, M.; Yu, S. H. Fire-Retardant and Thermally Insulating Phenolic-Silica Aerogels. Angewandte Chemie-International Edition 2018, 57 (17), 4538-4542. DOI: 10.1002/anie.201711717.
Zhang, W.; Zhang, Y.; Lu, C. H.; Deng, Y. L. Aerogels from crosslinked cellulose nano/micro-fibrils and their fast shape recovery property in water. Journal of Materials Chemistry 2012, 22 (23), 11642-11650. DOI: 10.1039/c2jm30688c.
Zhang, X. X.; Liu, M. H.; Wang, H. K.; Yan, N.; Cai, Z. Y.; Yu, Y. Ultralight, hydrophobic, anisotropic bamboo-derived cellulose nanofibrils aerogels with excellent shape recovery via freeze-casting. Carbohydrate Polymers 2019, 208, 232-240. DOI: 10.1016/j.carbpol.2018.12.073.
Zhang, X.; Zhao, X. Y.; Xue, T. T.; Yang, F.; Fan, W.; Liu, T. X. Bidirectional anisotropic polyimide/bacterial cellulose aerogels by freeze-drying for super-thermal insulation. Chemical Engineering Journal 2020, 385, 123963. DOI: 10.1016/j.cej.2019.123963.
Zhang, F.; Si, Y.; Yu, J. Y.; Ding, B. Sub-Nanoporous Engineered Fibrous Aerogel Molecular Sieves with Nanogating Channels for Reversible Molecular Separation. Small 2022, 18 (25). DOI: 10.1002/smll.202202173.
Zhang, Q. R.; Ma, L.; Xue, T. T.; Tian, J.; Fan, W.; Liu, T. X. Flame-retardant and thermal-protective polyimide-hydroxyapatite aerogel fiber-based composite textile for firefighting clothing. Composites Part B-Engineering 2023, 248. DOI: 10.1016/j.compositesb.2022.110377.
Zhu, Y. L.; Yu, Z. Y.; Zhu, J. Y.; Zhang, Y. F.; Ren, X. Y.; Jiang, F. Developing flame-retardant lignocellulosic nanofibrils through reactive deep eutectic solvent treatment for thermal insulation. Chemical Engineering Journal 2022a, 445. DOI: 10.1016/j.cej.2022.136748.
Zhu, Y. L.; Zhu, J. Y.; Yu, Z. Y.; Ye, Y. H.; Sun, X.; Zhang, Y. F.; Zhu, P. H.; Jiang, F. Air drying scalable production of hydrophobic, mechanically stable, and thermally insulating lignocellulosic foam. Chemical Engineering Journal 2022b, 450. DOI: 10.1016/j.cej.2022.138300.

1. A method of preparing an aerogel, the method comprising:
freezing a suspension comprising high aspect ratio microfibers; and
freeze-drying the frozen suspension to obtain the aerogel.

2. The method of claim 1, wherein the microfibers have an average diameter of from about 1 μm to about 50 μm and an average aspect ratio of from about 40 to about 130.

3. The method of claim 2, wherein the microfibers have an average diameter of from about 4 μm to about 10 μm and an average aspect ratio of from about 100 to about 120.

4. The method of claim 1, wherein the microfibers comprise cellulose.

5. The method of claim 4, wherein the microfibers are derived from bast fiber.

6. The method of claim 5, wherein the bast fiber is from hemp, jute, flax, ramie, kenaf, bamboo or combinations thereof.

7. The method of claim 6, wherein the bast fiber is from hemp.

8. The method of claim 7, wherein the bast fiber has been delignified.

9. The method of claim 4, wherein the microfibers are prepared by a method comprising mechanical defibrillation.

10. The method of claim 1, wherein the suspension comprises a solvent selected from water, tert-butanol, dimethyl sulfoxide and mixtures thereof.

11. The method of claim 10, wherein the suspension is an aqueous suspension comprising the microfibers in an amount of from about 0.01 wt % to about 2 wt %, based on the total weight of the aqueous suspension.

12. The method of claim 11, wherein the aqueous suspension comprises the microfibers in an amount of about 0.2 wt %, based on the total weight of the aqueous suspension.

13. The method of claim 1, wherein the suspension further comprises a crosslinking agent.

14. The method of claim 13, wherein the crosslinking agent comprises polyamideamine-epichlorohydrin.

15. The method of claim 14, wherein the crosslinking agent is present in the suspension in an amount of from about 0.1 wt % to about 2 wt %, based on the amount of the microfibers.

16. The method of claim 1, wherein the freezing is at a temperature in the range of from about −4° C. to about −50° C.

17. The method of claim 16, wherein the temperature is about −20° C.

18. The method of claim 1, wherein the method further comprises modifying a surface of the aerogel with a hydrophobic surface modifying agent.

19. The method of claim 18, wherein the modifying the surface comprises chemical vapor deposition of methyltrimethoxysilane.

20. An aerogel prepared by the method of claim 1.

21. An aerogel comprising a honeycomb structure, wherein cell walls of the honeycomb structure comprise high aspect ratio microfibers.

22-38. (canceled)

39. An apparel or outdoor gear comprising the aerogel of claim 20 as a thermal insulator.

40-41. (canceled)
